(19) United States
(12) Patent Application Publication
(10) Pub. No.: US 2007/0048793 A1
(43) Pub. Date: Mar. 1, 2007

(54) Compositions and methods for biocatalytic engineering

(76) Inventor: Brian M. Baynes, Cambridge, MA (US)

Correspondence Address: FISH & NEAVE IP GROUP;ROPES & GRAY LLP, ONE INTERNATIONAL PLACE, BOSTON, MA, 02110-2624, US

(21) Appl. No.: 11/485,848

(22) Filed: Jul. 12, 2006

Related U.S. Application Data
(60) Provisional application No. 60/698,337, filed on Jul. 12, 2005.

(51) Int. Cl. C40B 30/06; C40B 50/06

(52) U.S. Cl. 435/7.1; 435/488; 435/252.33

(57) ABSTRACT

Provided herein are compositions and methods for metabolic pathway engineering. The methods involve combining two or more cells expressing potential pathway proteins extracellularly in the presence of reactants. Also provided are libraries of cells expressing a plurality of pathway components and/or a plurality of variants of a given pathway component extracellularly.

### RELATED APPLICATIONS

This application claims the benefit of U.S. Provisional Application No. 60/698,337, filed Jul. 12, 2005, which application is hereby incorporated by reference in its entirety.

### BACKGROUND

Natural products cover an enormous diversity of chemical structures and biological functions. However rich this pool of natural structures, it is but a tiny fraction of the structures that could be made biologically—this essentially infinite bank of possible functional molecules is an irresistible target for biological design. Furthermore, many known biologically-active compounds are only found in trace quantities in their natural sources and are difficult or impossible to synthesize chemically. Driving the field of metabolic engineering is the hope that recombinant cells can serve as biosynthetic factories, and possibly even as sources of new molecular diversity (Bailey, J. E., Nature Biotech, 1999;17:616-618; Reynolds, K. A., Proc. Nat'l. Acad. Sci. USA, 1998;95:12744-12746; Cane, et al., Biochemistry, 1999;38:1643-1651; and, Lau, et al., Nature, 1994;370:389-391).

One strategy to create new and improved compounds synthesized in biological systems, e.g., in hosts such as bacteria, yeast, fungi, algae, and plants, is to alter one or more functions of enzymes involved in the biosynthetic pathway of a compound. However, modifying an enzymatic pathway by rational protein design requires extensive knowledge of structure-function relationships of the enzymes of the pathway, which makes this option unrealistic.

Combinatorial biosynthesis is becoming a key expression in biotechnology and biochemistry, but only a very limited number of examples exist. The power of combinatorial biosynthesis has, for instance, been demonstrated for the synthesis of novel polyketides. Here, mixing and matching of the modular components of polyketide synthases (PKS) have led to the production of novel polyketides and to new mechanistic insights into their structure and function (Carrera and Santi, Currr. Opin. Biotechnol., 1998;9:403-411; Koshla, et al., Biotechnol. Bioeng., 1996;52:122-128; Xue and Sherman, Nature2000;403:571-575, Tanget al., Science 2000;287:640-642).

Unfortunately, biosynthesis of polyketides represents a rather special example of a biosynthetic pathway. Metabolic pathways are usually composed of several enzymes, catalyzing completely different reactions in contrast to the repeated condensations between carboxylic acid derivatives catalyzed by the PKS modules. Thus, as opposed to polyketide biosynthesis, creation of organic molecule diversity usually requires changing enzyme functions involved in metabolic pathways and/or mixing and matching of enzymes from different origins in a tailor-made pathway. Furthermore, the combinatorial methods applied in polyketide biosynthesis so far are limited to moderate alterations of the PKS complex, involving empirical gene fusion approaches such as domain interaction, substitutions or additions, to create hybrid polyketides, not the addition of new functions foreign to this pathway.

Apart from novel biosynthetic pathways, an important application for metabolic engineering is to explore and improve biodegradation pathways. Biotechnological processes to destroy toxic wastes are particularly challenged by problems such as mixtures of waste compounds, too high or too low concentrations, inhibitory or toxic compounds, bioavailability and biodegradation rate. For instance, aromatic compounds carrying different chemical substituents represent an important class of xenobiotics. The substituents are often responsible for the low biodegradability of these compounds. Nevertheless, microbial communities exposed to xenobiotic compounds can often adapt to these chemicals, and microorganisms that metabolize them incompletely or completely have been isolated. However, depending on the aromatic xenobiotic and the enzyme composition of catabolic pathways of a certain microorganism, degradation can be either very slow or can lead to the accumulation of intermediates that are not further metabolized and which can be more toxic than the original xenobiotic. This is especially true for many nitro- and chloroaromatic compounds (Pieper, D. H., et al., Naturwissenschaften 1996;83:201-213, Fetzner, S., Appl. Microbiol. Biotechnol. 1998;50:633-657). Metabolic engineering approaches to the design of strains with novel biodegradation capabilities have mainly been based on the combination of pathway modules from different strains, thus creating hybrid pathways (Lee, J-Y, et al., Appl. Environ. Microbiol. 1995;61:2211-2217, Panke, S., et al., Appl. Environ. Microbiol. 1998;64:748-75 1, Reineke, W. Ann. Rev. Microbiol. 1998;52:287-331, Timmis, K. N., et al., Steffan, R. J. and Untermann, R., Annu Rev Microbiol. 1994;48:525-557). This has led to additional biodegradation abilities of those designed microorganisms. Improvements of catalyst quality and performance needed for effective biodegradation processes, however, are rarely achieved.

Directed evolution has become a powerful tool for the alteration of enzyme functions over the last few years (Kuchner and Arnold, TIBtech. 1997;15:523). Typically, evolutionary processes are mimicked in a test tube by random mutagenesis and/or DNA-shuffling of genes in combination with an efficient screening of the created library. This technique has led, in a relatively short time, to the generation of novel enzyme variants with optimized properties for biotechnological applications. For example a p-nitrobenzyl esterase was evolved by four generations of random mutagenesis and two rounds of recombination to yield an enzyme 150-fold more active (in 15-20% DMF) than the wildtype protein (Moore and Arnold, Nat. Biotechnol., 1996; 14:458 and Moore et al., J. Mol. Biol., 1997;272:336). DNA shuffling of a family of cephalosphorinase genes led to a 540 fold increase of moxalactamase activity (Cramer et al., Nature, 1998;391:288). However, it has not been shown that genes with the required synthesis or degradation potential can be selected from nature, adapted and assembled into new pathways for biological products used in medicine or agriculture.

Thus, there is a need in the art for strategies to recreate pathways in recombinant hosts to optimize the production of useful compounds. This is particularly true for complex chemical compounds requiring multi-step synthesis, suffering from low yields and, accordingly, low availability and/or high prices. There is a further need for new structures having improved and/or novel qualities over the original compounds, requiring the development of new pathways for their synthesis. Especially, libraries of synthetic pathways could provide a wide range of compounds never before synthesized in a particular host, or at all. There is also a need in the art for new and improved biodegradation pathways, either to produce metabolites of interest or for degrading waste products. The present invention addresses these and other needs in the art.

### SUMMARY

Traditional metabolic engineering approaches have several limitations. First, introducing new genes and/or pathways into cells disturbs the intracellular metabolic flux which may affect viability of the cell. Second, intermediates produced by metabolic pathways may be cytotoxic resulting in death of the cell and inability to conduct pathway engineering. Finally, pathway engineering may require testing combinations of many different proteins and/or a plurality of variants of any given protein in a pathway resulting in a large number of possible pathways to construct and test for activity. Construction of cells containing all possible variants of the pathways is extremely time consuming.

We have now developed a method for pathway engineering that addresses many of these limitations. In particular, one possible way to solve the above problems is to perform the catalytic steps that carry out a desired transformation outside the cell rather than inside it. To do this, the necessary enzymes must be transported outside the cell, and either displayed on its surface (as in phage display or yeast display) or released into the media.

In addition to remedying the above problems, this strategy has some other key advantages. First, cells expressing different surface enzymes provide interchangeable, reusable components that can be quickly combined with other mixtures of cells for pathway engineering. Second, the mix of cells in the reactor can be controlled externally without affecting the cells themselves (unlike intracellular metabolic engineering where making a pathway change affects the host cell). Third, the mix of cells can be self-regulating. For example, cells carrying a gene encoding an enzyme that converts A to B can be constructed so as to proliferate or upregulate the enzyme that converts A to B in the presence of A in the media. Finally, reactants, intermediates, co-factors and products can be added and removed from the media continuously as needed without lysing or permeabilizing the cells. For example, toxic reactants, intermediates or products can be maintained at a level that does not damage the cells either by controlling the amount added to the reaction or by removing a toxic component as it builds up in the reaction mixture. Additionally, since the enzymes are expressed extracellularly, there are no concerns about achieving sufficient cell uptake of reactants and no need to permeabliize the cells to enhance cell uptake.

The methods described herein may be used in conjunction with cell libraries that provide extracellular expression of a library of proteins useful for pathway engineering. Different combinations of the library members may be mixed to produce different pathways that may be tested for production of a desired product without the need to engineer a cell expressing the pathway in each instance. Reactants may be provided to the culture media and the production of intermediates and/or products monitored in the culture media.

In one aspect, the invention provides a method for engineering a pathway that produces a desired product, comprising (1) mixing two or more cells each of which expresses at least one potential biosynthetic pathway component that is secreted or transported to the membrane of the cell; (2) adding to the mixture a precursor of the desired product; and (3) allowing the pathway components in the mixture to chemically alter the precursor in the reaction mixture to produce the desired product.

In another aspect, the invention provides a method for engineering a pathway for biodegradation of an input substance, comprising (1) mixing two or more cells each of which expresses at least one potential biodegradation pathway component that is secreted or transported to the membrane of the cell; (2) adding to the mixture an input substance for degradation; and (3) allowing the pathway components in the mixture to degrade the input substance.

In one aspect, the invention provides a method for engineering a pathway that produces a desired product, comprising: (i) mixing two or more cells in a reaction mixture comprising a substrate for the pathway, wherein said cells extracellularly express potential pathway components; and (ii) assaying the reaction mixture for production of the desired product.

In certain embodiments, the cells may express the potential pathway components on the cell surface. In other embodiments, the cells may secrete the potential pathway components into the extracellular environment.

In certain embodiments, the cells may be prokaryotic cells, such as, for example, bacterial cells, or eukaryotic cells, such as, for example, yeast cells. In an exemplary embodiment, the cells may be E. coli.

In certain embodiments, three or more cells may be mixed in the reaction mixture. In other embodiments, a plurality of cells may be mixed in the reaction mixture.

In certain embodiments, expression of the potential pathway components is dependent on the presence of an appropriate substrate in the reaction mixture. In other embodiments, viability or proliferation of a cell expressing a potential pathway component is regulatable. For example, viability or proliferation of a cell expressing a potential pathway component may be dependent on the presence of a component in the reaction mixture.

In certain embodiments, each cell may expresses at least one potential pathway component. In other embodiments, at least one cell expresses at least two potential pathway components.

In another aspect, the invention provides a method for engineering a pathway for biodegradation of an input substance, comprising: (i) mixing two or more cells in a reaction mixture comprising an input substance for degradation by the pathway, wherein said cells extracellularly express potential pathway components; and (ii) assaying the reaction mixture for degradation of the input substance.

In certain embodiments, the reaction mixture may assayed for disappearance of the input substance. In other embodiments, the reaction mixture may be assayed for production of a breakdown product.

In another aspect, the invention provides a library comprising a plurality of cells extracellularly expressing a plurality of potential pathway components. In certain embodiments, the cells of the library express said potential pathway components on the cell surface. In other embodiments, the cells of the library secrete said potential pathway components into the extracellular environment. In certain embodiments, the plurality of potential pathway components comprise enzymes involved in a biodegradation pathway, or variants thereof. In other embodiments, the plurality of potential pathway components comprise enzymes involved in a biosynthetic pathway, or variants thereof. In certain embodiments, the plurality of potential pathway components comprise two or more variants of at least one metabolic or catabolic enzyme. In another embodiment, the plurality of potential pathway components comprise a plurality of variants of at least one metabolic or catabolic enzyme. In certain embodiments, each cell expresses at least one potential pathway component. In other embodiments, at least one cell expresses at least two potential pathway components. In another embodiment, a plurality of cells each express at least two potential pathway components.

The appended claims are incorporated into this section by reference.

### DETAILED DESCRIPTION

1. Definitions

As used herein, the following terms and phrases shall have the meanings set forth below. Unless defined otherwise, all technical and scientific terms used herein have the same meaning as commonly understood to one of ordinary skill in the art.

The singular forms “a,” “an,” and “the” include plural reference unless the context clearly dictates otherwise.

The terms “comprise” and “comprising” are used in the inclusive, open sense, meaning that additional elements may be included.

The term “including” is used to mean “including but not limited to”. “Including” and “including but not limited to” are used interchangeably.

The term “metabolic pathway” refers to a series of two or more enzymatic reactions in which the product of one enzymatic reaction becomes the substrate for the next enzymatic reaction. At each step of a metabolic pathway, intermediate compounds are formed and utilized as substrates for a subsequent step. These compounds may be called “metabolic intermediates.” The products of each step are also called “metabolites.”

As used herein, the term “transfection” means the introduction of a nucleic acid, e.g., an expression vector, into a recipient cell, and is intended to include commonly used terms such as “infect” with respect to a virus or viral vector. The term “transduction” is generally used herein when the transfection with a nucleic acid is by viral delivery of the nucleic acid. The term “transformation” refers to any method for introducing foreign molecules, such as DNA, into a cell. Lipofection, DEAE-dextran-mediated transfection, microinjection, protoplast fusion, calcium phosphate precipitation, retroviral delivery, electroporation, natural transformation, and biolistic transformation are just a few of the methods known to those skilled in the art which may be used.

Constructs for extracellular expression of proteins as described above may be introduced into the host cell by any methods known in the art. Any means for the introduction of polynucleotides into eukaryotic or prokaryotic cells may be used in accordance with the compositions and methods described herein. Suitable methods include, for example, direct needle microinjection, transfection, electroporation, retroviruses, adenoviruses, adeno-associated viruses; Herpes viruses, and other viral packaging and delivery systems, polyamidoamine dendrimers, liposomes, and more recently techniques using DNA-coated microprojectiles delivered with a gene gun (called a biolistics device), or narrow-beam lasers (laser-poration). In one embodiment, nucleic acid constructs may be delivered in a complex with a colloidal dispersion system. A colloidal system includes macromolecule complexes, nanocapsules, microspheres, beads, and lipid-based systems including oil-in-water emulsions, micelles, mixed micelles, and liposomes. An exemplary colloidal system of this invention is a lipid-complexed or liposome-formulated DNA. See, e.g., Canonico et al, Am J Respir Cell Mol Biol 10:24-29, 1994; Tsan et al, Am J Physiol 268 (6 Pt 1): 1052-6 (1995); Alton et al., Nat Genet. 5:135-142, 1993 and U.S. Pat. No. 5,679,647 by Carson et al.

2. Biocatalytic Engineering Methods and Compositions

In one embodiment, the invention provides methods for designing a biosynthetic (e.g., metabolic) or biodegradative (e.g., bioremediation, catabolic) pathway. The methods involve mixing cells that extracellularly express proteins in the presence of a reaction mixture that comprises substrates for the pathway. The methods permit rapid testing of various combinations of potential pathway components (e.g., metabolic enzymes, catabolic enzymes, and variants thereof, etc.) without the need to construct the pathway in a single cell. Desired products, or degradation of input substances, are carried out extracellularly in the reaction mixture by the potential pathway components that are provided extracellularly by the cells. Successful synthesis of a desired product, or degradation of an input product, may be monitored by measuring reduction of an input product, production of an intermediate or production of a final product in the reaction mixture.

In certain embodiments, the methods involve mixing a plurality of cells expressing a plurality of different potential pathway components in a single reaction mixture. For example, at least about 2, 3, 4, 5, 6, 7, 8, 9, 10, or more cells extracellularly expressing potential pathway components may be mixed in a single reaction mixture. In certain embodiments, the potential pathway components may be enzymes known to be involved in a known biosynthetic and/or biodegradative pathway. In other embodiments, the potential pathway components may be proteins not known to be involved in a biosynthetic or biodegradative pathway but which may have an activity that could be useful in a metabolic or catabolic pathway. In yet other embodiments, the potential pathway components are variants of any of the foregoing. Such variants may be produced by random mutagenesis or may be produced by rational design for production of an enzymatic activity having, for example, an altered substrate specificity, increased enzymatic activity, greater stability, etc.

In various embodiments, a reaction mixture may comprise any combination of potential pathway components. For example, a reaction mixture may comprise two or more pathway components from a know pathway in combination with a protein not normally involved in the pathway. In another embodiment, a reaction mixture may comprise a mixture of pathway components from two or more known pathways which are not typically found in the same pathway. Such components may be from pathways normally found in different organisms or from two or more pathways found in the same organism. In yet another embodiment, a reaction mixture for pathway design may comprise two or more potential pathway components that are proteins not normally involved in known biosynthetic or biodegradative pathway. In another embodiment, the reaction mixture may comprise one or more variants of known pathway components or other proteins of interest. Various combinations of the foregoing are also contemplated herein.

In accordance with the methods described herein, reaction mixtures for pathway development may be carried out in any vessel that permits cell growth and/or incubation. For example, a reaction mixture may be a bioreactor, a cell culture flask or plate, a multiwell plate (e.g., a 96, 384, 1056 well microtiter plates, etc.), a fermentor, etc. In an exemplary embodiment, a reaction mixture may be carried out in a microfluidics device which permits addition of reactants (e.g., substrates, input products for biodegradation, nutrients, etc.) and/or removal of intermediates and/or products. Use of a microfluidics device is particularly useful when carrying out reactions that may involve toxic compounds as it permits control over the amount of the toxic substance in the mixture (e.g., a toxic product may be removed from the reaction as it is produced so it does not accumulate to levels high enough to damage cells or a toxic input product may be slowly added to the reaction mixture without ever needing to raise the concentration above a level which may damage the cells, etc.). In addition to controlling input and output of nutrients in the reaction mixture, a microfluidics device may be used to add or remove cells extracellularly expressing enzymes to or from the reaction mixture. For example, a microfluidics device may be used to control the enzyme ratio in the reaction mixture, e.g., by controlling the amount of cells expressing a first enzyme relative to the amount of cells expressing a second enzyme that are present in the reaction mixture. This may be useful in controlling the speed of the reaction or the amount of product that is produced. Furthermore, a microfluidics device may be used to sequentially add cells that extracellularly express an enzyme into the reaction mixture. For example, if enzyme one converts A into B, enzyme two converts B into C and enzyme three converts C into D, then the microfludics device can be used to control the timing of addition of cells extracellularly expressing enzyme one, two and three into the reaction mixture. The cells may be added sequentially to the reaction as the substrate for the appropriate enzyme builds up in the mixture (e.g., add cells expressing enzyme two as B builds up in the mixture) and/or may be removed from the reaction mixture as the product of the enzyme reaction builds up in the mixture (e.g., remove cells expressing enzyme two as C builds up in the mixture). In certain embodiments, metabolic or catabolic pathways may be carried out serially using combinations of cells wherein cell types expressing different enzymes are never mixed together in the same reaction chamber. For example, a microfluidics device may be used to mix substrate A with cells extracellularly expressing enzyme one. The product of this reaction, B, is then moved by the device to another reaction chamber containing cells extracellularly expressing enzyme two which will convert B into C, etc. Such techniques will help to avoid competition between different cell types, for example, by overgrowth of one cell type relative to another in a single reaction mixture which could obscure results. Examples of microfluidic devices that may be used in accordance with the compositions and methods described herein include, for example, the devices described in U.S. Patent Publication Nos. 2005/008999 and 2006/0141607.

In another embodiment, the invention provides a composition comprising at least one cell that extracellularly expresses an enzyme. In other embodiments, the composition may comprise at least 2, 3, 4, 5, 6, 7, 8, 9, 10 or more cells that each extracellularly express a different enzyme. In other embodiments, the invention provides compositions comprising at least one cell that extracellularly expresses at least two different enzymes on or from the same cell. In other embodiments, the composition may comprise at least one cell that extracellularly expresses at least 2, 3, 4, 5, 6, 7, 8, 9, 10 or more different enzymes on or from the same cell. In other embodiments, the composition may comprise at least 2, 3, 4, 5, 6, 7, 8, 9, 10 or more cells that each extracellularly express two or more different enzymes. When an individual cell extracellularly expresses more than one enzyme, any combination of enzymes may be used. In certain embodiments, it may be desirable to utilize combinations of enzymes in association with an individual cell that will be commonly found together in a pathway. For example, creation of a flexible reagent that can be used in a number of different contexts can be created by pairing together two enzymes that are common components of several different metabolic and/or catabolic pathways. The extracellular expression may be expression on the surface of the cells (e.g., surface display) or secretion of the enzyme into the extracellular environment. In certain embodiments, expression of the enzyme may be controlled by an inducible or repressible promoter. Exemplary enzymes include, for example, metabolic enzymes or catabolic enzymes, such as those described herein below. In certain embodiments, the compositions may be contained in a reactor, tube, fermentor, culture flask, microtiter plate, or other vessel for cell growth or incubation.

In an exemplary embodiment, the invention provides a composition comprising one or more cells extracellularly expressing a metabolic pathway for the production of amorphadiene and appropriate substrates therefore (see e.g., Martin et al., Nature Biotech. 21: 796-802 (2003)). In one embodiment, the composition comprises a plurality of cells each expressing a different enzyme in the amorphadiene metabolic pathway. In another necessary for amorphadiene synthesis.

In yet another embodiment, the invention provides libraries of cells that extracellularly express potential pathway components. In certain embodiments, the libraries may comprise a plurality of enzymes from known biosynthetic or biodegradative pathways, a plurality of proteins not known to be involved in a metabolic or catabolic pathway, variants of any of the foregoing, and various combinations thereof. The libraries may be provided, for example, in a microtiter plate wherein each well corresponds to a cell expressing a different protein extracellularly, e.g., either on the surface of the cell or by secretion from the cell. The libraries may be stored and components from the libraries may be accessed and used to form different combinations for assaying a variety of pathway combinations. In one embodiment, the library may comprise a plurality of variants of a given enzyme which may be assayed for maximal activity in a given pathway.

In certain embodiments, the cells may be constructed such that expression of the potential pathway component is regulatable, e.g., expression may be controlled upon addition of an inducer (or removal of a repressor). In an exemplary embodiment, expression of the potential pathway component may be dependent upon the presence of a substrate that the pathway component will act on in the reaction mixture. For example, expression of an enzyme that catalyzes conversion of A to B may be induced in the presence of A in the media. Expression of such pathway components may be induced in accordance with the methods of the invention either by adding the compound that causes induction or by the natural build-up of the compound during the process of the biosynthetic pathway (e.g., the inducer may be an intermediate produced during the biosynthetic process to yield a desired product). In an exemplary embodiment, methods for controlling gene expression may be based on the use of riboswitches as described, for example, in U.S. Patent Publication No. 2005/0053951.

In certain embodiments, cells that extracellularly express potential pathway components may be engineered so that growth, proliferation and/or viability of the cells are regulatable. For example, growth, proliferation and/or viability of a cell may be controlled by adding an exogenous factor into the reaction mixture and/or by removing a factor from the reaction mixture. Examples of factors that may be added or removed from the reaction mixture include nutrients necessary for growth of an auxotrophic cell type (or partial auxotrophic cell type), compounds that up-regulate or down-regulate genes necessary for viability or proliferation of a cell (e.g., up-regulating genes necessary for growth or cell division or down-regulating inhibitory or toxic genes), toxic factors, etc. In certain embodiments, cells may be engineered such that their growth, proliferation and/or viability are dependent on an intermediate in a metabolic or catabolic pathway (e.g., by use of a riboswitch as described above). By controlling growth, proliferation and/or viability of a cell that extracellularly expresses an enzyme in the reaction mixture, one can control the ratio of enzymes in the mixture. This type of control may help to prevent competition between different cell types and prevent one cell type from taking over the reaction mixture and potentially interfering with the functioning of the metabolic or catabolic pathway. For example, in a pathway involving enzyme one (A→B), enzyme two (B→C) and enzyme three (C→D), it may be desirable to upregulate proliferation of cells expressing enzyme two only when the appropriate level of B is built up in the reaction mixture. Similarly, it may be desirable to kill off or down regulate proliferation of cells expressing enzyme two when a desired level of C has been achieved in the reaction mixture.

3. Extracellular Protein Expression

In various embodiment, the methods and compositions disclosed herein utilize extracellular expression of proteins of interest. Extracellular expression includes both surface display (e.g., proteins displayed or anchored on the surface of a cell) as well as secretion of a protein from a cell. Extracellular expression of proteins may be achieved in a variety of cells or organisms include prokaryotes, eukaryotes and viruses (including bacteriophage). Methods for extracellular protein expression are described for example, in Kostakioti et al., J. Bacteriology 187: 4306-4314 (2005); U.S. Patent Publication Nos. 2004/0146976, 2004/0076976; 2004/0146976; 2004/0005539; 2003/0104604; 2004/0171065; 2005/0118685; 2005/0124042; 2005/0019857; 2004/0126847; 2004/0115790; 2004/0115775; 2003/0180937; and U.S. Pat. No. 5,516,637.

Exemplary host cells or organisms for surface expression of proteins include, for example, vegetative bacterial cells, bacterial spores and bacterial DNA viruses. Eukaryotic cells may be used as host cells but have longer dividing times and more stringent nutritional requirements than do bacteria. They are also more fragile than bacterial cells and therefore more difficult to manipulate without damage. Eukaryotic viruses could be used instead of bacteriophage but must be propagated in eukaryotic cells and therefore suffer from some of the amplification problems mentioned above.

When the host cell is a bacterial cell, or a phage which is assembled periplasmically, the display means has two components. The first component is a secretion signal which directs the initial expression product to the inner membrane of the cell (a host cell when the package is a phage). This secretion signal is cleaved off by a signal peptidase to yield a processed, mature, potential binding protein. The second component is an outer surface transport signal which directs the host to assemble the processed protein into its outer surface. Preferably, this outer surface transport signal is derived from a surface protein native to the host organism.

A protein for extracellular expression may be expressed from a hybrid gene. For example, a hybrid gene may comprise a DNA encoding a protein of interest operably linked to a signal sequence (e.g., the signal sequences of the bacterial phoA or b1a genes or the signal sequence of M13 phage gene III) and to DNA encoding a coat protein (e.g., the M13 gene III or gene VIII proteins) of a filamentous phage (e.g., M13). The expression product is transported to the inner membrane (lipid bilayer) of the host cell, whereupon the signal peptide is cleaved off to leave a processed hybrid protein. The C-terminus of the coat protein-like component of this hybrid protein is trapped in the lipid bilayer, so that the hybrid protein does not escape into the periplasmic space. (This is typical of the wild-type coat protein.) As the single-stranded DNA of the nascent phage particle passes into the periplasmic space, it collects both wild-type coat protein and the hybrid protein from the lipid bilayer. The hybrid protein is thus packaged into the surface sheath of the filamentous phage, leaving the potential binding domain exposed on its outer surface.

When the host organism is a bacterial spore, or a phage whose coat is assembled intracellularly, a secretion signal directing the expression product to the inner membrane of the host bacterial cell is unnecessary. In these cases, the display means is merely the outer surface transport signal, typically a derivative of a spore or phage coat protein.

In certain embodiments, viruses may be used as the host organisms for surface display. The virus is preferably a DNA virus with a genome size of 2 kb to 10 kb base pairs, such as (but not limited to) the filamentous (Ff) phage M13, fd, and f1; the IncN specific phage Ike and If1; IncP-specific Pseudomonas aeruginosa phage Pf1 and Pf3; and the Xanthomonas oryzae phage Xf.

When the host organism is M13, the gene III and the gene VIII proteins are highly preferred as fusion proteins for targeting expression of a desired protein on the surface of the host. The proteins from genes VI, VII, and IX may also be used. When the host organism is Pf3, a fusion protein with the mature coat protein of Pf3 may be used for surface expression.

Another vehicle for surface display of a desired protein is by expressing it as a domain of a chimeric gene containing part or all of gene III. This gene encodes one of the minor coat proteins of M13. Genes VI, VII, and IX also encode minor coat proteins. Each of these minor proteins is present in about 5 copies per virion and is related to morphogenesis or infection. In contrast, the major coat protein is present in more than 2500 copies per virion. The gene VI, VII, and IX proteins are present at the ends of the virion; these three proteins are not post-translationally processed. When bacteriophage φX174 is used as a host, surface display may be achieved using fusions three gene products of φX174 that are present on the outside of the mature virion: F (capsid), G (major spike protein, 60 copies per virion), and H (minor spike protein, 12 copies per virion).

Exemplary bacterial cells that may be used as hosts for surface display of proteins include, for example, Salmonella typhimurium, Bacillus subtilis, Pseudomonas aeruginosa, Vibrio cholerae, Klebsiella pneumonia, Neisseria gonorrhoeae, Neisseria meningitidis, Bacteroides nodosus, Moraxella bovis, and especially Escherichia coli. When E. coli is used as the host cell, surface display of a desired protein may be carried out by making fusions with one or more of the following proteins (or fragments thereof): LamB, OmpA, OmpC, OmpF, PhoE, BtuB, FepA, FhuA, IutA, FecA, FhuE, and pilin. The E. coli LamB has been expressed in functional form in S. typhimurium, V. cholerae, and K. pneumonia, permitting surface expression of a desired protein in these host cells as a fusion to E. coli LamB. In K. pneumonia, a maltoporin similar to LamB may be used for surface expression and in P. aeruginosa, the DI protein (a homologue of LamB) can be used. For display on the surface of N. gonorrhoeae, fusion to Protein IA may be used.

Bacterial spores have desirable properties as host organisms. Spores are much more resistant than vegetative bacterial cells or phage to chemical and physical agents. Bacteria of the genus Bacillus form endospores that are extremely resistant to damage by heat, radiation, desiccation, and toxic chemicals. Bacteria of the genus Clostridium also form very durable endospores, but clostridia, being strict anaerobes, are not convenient to culture. A desired protein may be displayed on the surface of B. subtilis by making fusions with cotC or cotD, or fragments thereof.

A number of methods have been devised to display peptides and proteins on the surfaces of bacteria and bacteriophages. The surface display of heterologous protein in bacteria has been implemented for various purposes, such as the production of live bacterial vaccine delivery systems (see, for example, Georgiou et al., U.S. Pat. No. 5,348,867; Huang et al., U.S. Pat. No. 5,516,637; Stahl and Uhlen, Trends Biotechnol. 15:185 (1995)). Bacterial surface display has been achieved using chimeric genes derived from bacterial outer membrane proteins, lipoproteins, fimbria proteins, and flagellar proteins. Bacteriophage display of foreign peptides and proteins has become a powerful tool for generating antigens, identifying peptide ligands, mapping enzyme substrate sites, isolation of high affinity antibodies, and the directed evolution of proteins (see, for example, Phizicky and Fields, Microbiol. Rev. 59:94 (1995); Kay et al., Phage Display of Peptides and Proteins (Academic Press 1996); Lowman, Annu. Rev. Biophys. Biomol. Struct. 26:401 (1997)).

Methods for cell surface display of heterologous proteins in eukaryotic cells have been described (see e.g., Boder and Wittrup, Nature Biotechnol. 15:553 (1997)). For example, Boder and Wittrup have described a library screening system using Saccharomyces cerevisiae as the displaying particle. This yeast surface display method uses the alpha-agglutinin yeast adhesion receptor, which consists of two subunits, Aga1 and Aga2. The Aga1 subunit is anchored to the cell wall via a beta-glucan covalent linkage, and Aga2 is linked to Aga1 by disulfide bonds. In this approach, recombinant yeast are produced that express Aga1 and an Aga2 fusion protein comprising a foreign polypeptide at the C-terminus of Aga2. Aga1 and the fusion protein associate within the secretory pathway of the yeast cell, and are expressed on the cell surface as a display scaffold.

Various approaches in eukaryotic systems achieve surface display by producing fusion proteins that contain the polypeptide of interest and a transmembrane domain from another protein to anchor the fusion protein to the cell membrane. In eukaryotic cells, the majority of secreted proteins and membrane-bound proteins are translocated across an endoplasmic reticulum membrane concurrently with translation (Wicker and Lodish, Science 230:400 (1985); Verner and Schatz, Science 241:1307 (1988); Hartmann et al., Proc. Nat'l Acad. Sci. USA 86:5786 (1989); Matlack et al., Cell 92:381 (1998)). In the first step of this co-translocational process, an N-terminal hydrophobic segment of the nascent polypeptide, called the “signal sequence,” is recognized by a signal recognition particle and targeted to the endoplasmic reticulum membrane by an interaction between the signal recognition particle and a membrane receptor. The signal sequence enters the endoplasmic reticulum membrane and the following nascent polypeptide chain begins to pass through the translocation apparatus in the endoplasmic reticulum membrane. The signal sequence of a secreted protein or a type I membrane protein is cleaved by a signal peptidase on the luminal side of the endoplasmic reticulum membrane and is excised from the translocating chain. The rest of the secreted protein chain is released into the lumen of the endoplasmic reticulum. A type I membrane protein is anchored in the membrane by a second hydrophobic segment, which is usually referred to as a “transmembrane domain.” The C-terminus of a type I membrane protein is located in the cytosol of the cell, while the N-teminus is displayed on the cell surface.

In contrast, certain proteins have a signal sequence that is not cleaved, a “signal anchor sequence,” which serves as a transmembrane segment. A signal anchor type I protein has a C-terminus that is located in the cytosol, which is similar to type I membrane proteins, whereas a signal anchor type II protein has an N-terminus that is located in the cytosol.

Several insect cell systems have been devised to express a fusion protein comprising a foreign amino acid sequence and a transmembrane domain. In one system, an expression vector was designed to allow fusion of a heterologous protein to the amino-terminus of the Autographa californica nuclear polyhedrosis virus major envelop glycoprotein, gp64 (Mottershead et al., Biochem. Biophys. Res. Commun. 238:717 (1997)). Gp64, a type I integral membrane protein, functions as an anchor for the heterologous amino acid sequence, which is displayed on the surface of baculovirus particles (Monsma and Blissard, J. Virol. 69:2583 (1995)). More recently, Ernst et al., Nucl. Acids Res. 26:1718 (1998), described a baculovirus surface display system for the production of an epitope library. In this case, a nucleotide sequence encoding a particular epitope was inserted into an influenza virus hemagglutinin gene. Influenza virus hemagglutinin, like gp64, is a type I integral membrane protein, which provides a membrane anchor for the foreign amino acid sequence (see, for example, Lamb and Krug, “Orthomyxoviridae: The Viruses and Their Replication,” in Fundamental Virology, 3rd Edition, pages 606-647 (Lippincott-Raven Publishers 1996)).

pDisplay™ is an example of a commercially available vector that is used to display a polypeptide on the surface of a mammalian cell (IVITROGEN Corp.; Carlsbad, Calif.). In this vector, a multiple cloning site resides between sequences that encode two identifiable peptides, hemagglutinin A and myc epitopes. The vector also includes sequences that encode an N-terminal signal peptide derived from a murine immunoglobulin kappa-chain, and a type I transmembrane domain of platelet-derived growth factor receptor, located at the C-terminus. In this way, a protein of interest is expressed by a transfected cell as an extracellular fusion protein, anchored to the plasma membrane at the fusion protein C-terminus by the transmembrane domain.

In certain embodiments, the methods and compositions described herein may used in conjunction with proteins secreted from a host cell. A variety of host cells may be used for producing protein secreted into the extracellular environment, including, for example, prokaryotic cells such as bacteria, and eukaryotic cells, such as yeast.

Proteins destined for secretion from the cytoplasm are synthesized with an N-terminal peptide extension of generally between 15-30 amino acids known as the leader peptide. The leader peptide is proteolytically removed from the mature protein either concomitant to or immediately following export into an exocytoplasmic location.

Recent findings have established that there are actually four protein export pathways in Gram-negative bacteria (Stuart and Neupert, Nature, 406:575-577, 2000): the general secretory (Sec) pathway (Danese and Silhavy, Annu. Rev. Genet., 32:59-94, 1998; Pugsley, Microbiol. Rev., 57:50-108, 1993), the signal recognition particle (SRP)-dependent pathway (Meyer et al., Nature, 297:647-650, 1982), the recently discovered YidC-dependent pathway (Samuelson et al., Nature, 406:637-641, 2000) and the twin-arginine translocation (Tat) system (Berks, Mol. Microbiol., 22:393-404, 1996). With the first three of these pathways, polypeptides cross the membrane via a ‘threading’ mechanism, i.e., the unfolded polypeptides insert into a pore-like structure formed by the proteins SecY, SecE and SecG and are pulled across the membrane via a process that requires the hydrolysis of ATP (Schatz and Dobberstein, Science, 271:1519-1526, 1996).

In contrast, proteins exported through the Tat-pathway transverse the membrane in a partially or perhaps even fully folded conformation. The bacterial Tat system is closely related to the ‘ΔpH-dependent’ protein import pathway of the plant chloroplast thylakoid membrane (Settles et al., Science, 278:1467-1470, 1997). Export through the Tat pathway does not require ATP hydrolysis and does not involve passage through the SecY/E/G pore. In most instances, the natural substrates for this pathway are proteins that have to fold in the cytoplasm in order to acquire a range of cofactors such as FeS centers or molybdopterin. However, proteins that do not contain cofactors but fold too rapidly or too tightly to be exported via any other pathway can be secreted from the cytoplasm by fusing them to a Tat-specific leader peptide (Berks, Mol. Microbiol., 22:393-404, 1996; Berks et al., Mol. Microbiol., 35:260-274, 2000).

The membrane proteins TatA, TatB and TatC are essential components of the Tat translocase in E. coli (Sargent et al., EMBO J., 17:3640-3650, 1998; Weiner et al., Cell, 93:93-101, 1998). In addition, the TatA homologue TatE, although not essential, may also have a role in translocation and the involvement of other factors cannot be ruled out. TatA, TatB and TatE are all integral membrane proteins predicted to span the inner membrane once with their C-terminal domain facing the cytoplasm. The TatA and B proteins are predicted to be single-span proteins, whereas the TatC protein has six transmembrane segments and has been proposed to function as the translocation channel and receptor for preproteins (Berks et al., Mol. Microbiol., 35:260-274, 2000; Bogsch et al., J. Biol. Chem., 273:18003-18006, 1998; Chanal et al., Mol. Microbiol., 30:674-676, 1998). Mutagenesis of either TatB or C completely abolishes export (Bogsch et al., J. Biol. Chem., 273:18003-18006, 1998; Sargent et al., EMBO J., 17:3640-3650, 1998; Weiner et al., Cell, 93:93-101, 1998). The Tat complex purified from solubilized E. coli membranes contained only TatABC (Bolhuis et al., J. Biol. Chem., 276:20213-20219, 2001). In vitro reconstitution of the translocation complex demonstrated a minimal requirement for TatABC and an intact membrane potential (Yahr and Wickner, EMBO J., 20:2472-2479, 2001).

The choice of the leader peptides, and thus the pathway employed in the export of a particular protein, can determine whether correctly folded functional protein. will be produced (Bowden and Georgiou, J. Biol. Chem., 265:16760-16766, 1990; Thomas et al., Mol. Microbiol., 39:47-53, 2001). Feilmeier et al. (2000) have shown that fusion of the green fluorescent protein (GFP) to a Sec-specific leader peptide or to the C-terminal of the maltose binding protein (MBP which is also exported via the Sec pathway) resulted in export of green fluorescent protein and MBP-GFP into the periplasm (Feilmeier et al., J. Bacteriol., 182:4068-4076, 2000). However, green fluorescent protein in the periplasm was non-fluorescent indicating that the secreted protein was misfolded and thus the chromophore of the green fluorescent protein could not be formed. Since proteins exported via the Sec pathway transverse the membrane in an unfolded form, it was concluded that the environment in the bacterial secretory compartment (the periplasmic space) does not favor the folding of green fluorescent protein (Feilmeier et al., J. Bacteriol., 182:4068-4076, 2000). In contrast, fusion of a Tat-specific leader peptide to green fluorescent protein resulted in accumulation of fluorescent green fluorescent protein in the periplasmic space. In this case, the Tat-GFP propeptide was first able to fold in the cytoplasm and then be exported into the periplasmic space as a completely folded protein (Santini et al., J. Biol. Chem., 276:8159-8164, 2001; Thomas et al., Mol. Microbiol., 39:47-53, 2001). However, there has been no evidence that leader peptides other than TorA can be employed to export heterologous proteins into the periplasmic space of E. coli.

The cellular compartment where protein folding takes place can have a dramatic effect on the yield of a biologically active protein. The bacterial cytoplasm contains a large number of protein folding accessory factors, such as chaperones whose function and ability to facilitate folding of newly synthesized polypeptides is controlled by ATP hydrolysis. In contrast, the bacterial periplasm contains relatively few chaperones and there is no evidence that ATP is present in that compartment. Thus many proteins are unable to fold in the periplasm and can reach their native state only within the cytoplasmic milieu. The only known way to enable the secretion of folded proteins from the cytoplasm is via fusion to a Tat-specific leader peptide. However, the protein flux through the Tat export system is significantly lower than that of the more widely used Sec pathway. Consequently, the accumulation and steady state yield of proteins exported via the Tat pathway is low.

In one embodiment, proteins are secreted from bacterial cells via the sec-dependent or tat pathways. The first pathway is the sec-dependent pathway. This pathway is well characterized and a number of putative signal sequences have been described. It is intended that all sec-dependent signal peptides are to be encompassed by the present invention. Specific examples include but are not limited to the AmyL and the AprE sequences. The AmyL sequence refers to the signal sequence for alpha-amylase and AprE refers to the AprE signal peptide sequence (AprE is subtilisin (also called alkaline protease) of B. subtilis). The second pathway is the twin arginine translocation or Tat pathway. Similarly, it is intended that all tat-dependent signal peptides are to be encompassed by the present invention. Specific examples include but are not limited to the phoD and the lipA sequences.

In other embodiments, protein secretion from eukaryotic cells may be used in accordance with the methods described herein. In an exemplary embodiment, proteins may be secreted from yeast cells. A yeast signal peptide sequence may be a known naturally occurring signal sequence or a variant thereof that does not adversely affect the function of the signal peptide. Examples of signal peptides appropriate for the present invention include, but are not limited to, the signal peptide sequences for alpha-factor (see, for example, U.S. Pat. No. 5,602,034; Brake et al. (1984) Proc. Natl. Acad. Sci. USA 81:4642-4646); invertase (WO 84/01153); PHO5 (DK 3614/83); YAP3 (yeast aspartic protease 3; PCT Publication No. 95/02059); and BAR1 (PCT Publication No. 87/02670). Alternatively, the signal peptide sequence may be determined from genomic or cDNA libraries using hybridization probe techniques available in the art (see Sambrook et al. (1989) Molecular Cloning: A Laboratory Manual (Cold Spring Harbor Laboratory Press, Plainview, N.Y.), or even synthetically derived (see, for example, WO 92/11378).

During entry into the ER, the signal peptide is cleaved off the precursor polypeptide at a processing site. The processing site can comprise any peptide sequence that is recognized in vivo by a yeast proteolytic enzyme. This processing site may be the naturally occurring processing site for the signal peptide. More preferably, the naturally occurring processing site will be modified, or the processing site will be synthetically derived, so as to be a preferred processing site. By “preferred processing site” is intended a processing site that is cleaved in vivo by a yeast proteolytic enzyme more efficiently than is the naturally occurring site. Examples of preferred processing sites include, but are not limited to, dibasic peptides, particularly any combination of the two basic residues Lys and Arg, that is Lys-Lys, Lys-Arg, Arg-Lys, or Arg-Arg, most preferably Lys-Arg. These sites are cleaved by the endopeptidase encoded by the KEX2 gene of Saccharomyces cerevisiae (see Fuller et al. Microbiology 1986:273-278) or the equivalent protease of other yeast species (see Julius et al. (1983) Cell 32:839-852). In the event that the KEX2 endopeptidase would cleave a site within the peptide sequence for the mature heterologous protein of interest, other preferred processing sites could be utilized such that the peptide sequence of interest remains intact (see, for example, Sambrook et al. (1989) Molecular Cloning: A Laboratory Manual (Cold Spring Harbor Laboratory Press, Plainview, N.Y.).

A functional signal peptide sequence is essential to bring about extracellular secretion of a heterologous protein from a yeast cell. Additionally, the hybrid precursor polypeptide may comprise a secretion leader peptide sequence of a yeast secreted protein to further facilitate this secretion process. When present, the leader peptide sequence is generally positioned immediately 3′ to the signal peptide sequence processing site. By “secretion leader peptide sequence” (LP) is intended a peptide that directs movement of a precursor polypeptide, e.g. the hybrid precursor polypeptide comprising the mature heterologous protein to be secreted, from the ER to the Golgi apparatus and from there to a secretory vesicle for secretion across the cell membrane into the cell wall area and/or the growth medium. The leader peptide sequence may be native or heterologous to the yeast host cell but more preferably is native to the host cell.

The leader peptide sequence of the present invention may be a naturally occurring sequence for the same yeast secreted protein that served as the source of the signal peptide sequence, a naturally occurring sequence for a different yeast secreted protein, or a synthetic sequence (see, for example, WO 92/11378), or any variants thereof that do not adversely affect the function of the leader peptide.

For purposes of the invention, the leader peptide sequence when present is preferably derived from the same yeast secreted protein that served as the source of the signal peptide sequence, more preferably an alpha-factor protein. A number of genes encoding precursor alpha-factor proteins have been cloned and their combined signal-leader peptide sequences identified. See, for example, Singh et al. (1983) Nucleic Acids Res. 11:4049-4063; Kuijan et al., U.S. Pat. No. 4,546,082; U.S. Pat. No. 5,010,182; herein incorporated by reference. Alpha-factor signal-leader peptide sequences have been used to express heterologous proteins in yeast. See, for example, Elliott et al. (1983) Proc. Natl. Acad. Sci. USA 80:7080-7084; Bitter et al. (1984) Proc. Natl. Acad. Sci. 81:5330-5334; Smith et al. (1985) Science 229:1219-1229; and U.S. Pat. Nos. 4,849,407 and 5,219,759; herein incorporated by reference.

Alpha-factor, an oligopeptide mating pheromone approximately 13 residues in length, is produced from a larger precursor polypeptide of between about 100 and 200 residues in length, more typically about 120-160 residues. This precursor polypeptide comprises the signal sequence, which is about 19-23 (more typically 20-22 residues), the leader sequence, which is about 60 residues, and typically 2-6 tandem repeats of the mature pheromone sequence. Although the signal peptide sequence and full-length alpha-factor leader peptide sequence can be used, more preferably for this invention a truncated alpha-factor leader peptide sequence will be used with the signal peptide when both elements are present in the hybrid precursor molecule.

By “truncated” alpha-factor leader peptide sequence is intended a portion of the full-length alpha-factor leader peptide sequence that is about 20 to about 60 amino acid residues, preferably about 25 to about 50 residues, more preferably about 30 to about 40 residues in length. Methods for using truncated alpha-factor leader sequences to direct secretion of heterologous proteins in yeast are known in the art. See particularly U.S. Pat. No. 5,602,034. When the hybrid precursor polypeptide sequence comprises a truncated alpha-factor leader peptide, deletions to the full-length leader will preferably be from the C-terminal end and will be done in such a way as to retain at least one glycosylation site (-Asn-Y-Thr/Ser-, where Y is any amino acid residue) in the truncated peptide sequence. This glycosylation site, whose modification is within skill in the art, is retained to facilitate secretion (see particularly WO 89/02463).

When the hybrid precursor polypeptide sequence comprises a leader peptide sequence, such as the alpha-factor leader sequence, there will be a processing site immediately adjacent to the 3′ end of the leader peptide sequence. This processing site enables a proteolytic enzyme native to the yeast host cell to cleave the yeast secretion leader peptide sequence from the 5′ end of the native N-terminal propeptide sequence of the mature heterologous protein of interest, when present, or from the 5′ end of the peptide sequence for the mature heterologous protein of interest. The processing site can comprise any peptide sequence that is recognized in vivo by a yeast proteolytic enzyme such that the mature heterologous protein of interest can be processed correctly. The peptide sequence for this processing site may be a naturally occurring peptide sequence for the native processing site of the leader peptide sequence. More preferably, the naturally occurring processing site will be modified, or the processing site will be synthetically derived, so as to be a preferred processing site as described above.

4. Engineering Metabolic Pathways for Bioremediation

Modern industry generates many pollutants for which the environment can no longer be considered an infinite sink. Naturally occurring microorganisms are able to metabolize thousands of organic compounds, including many not found in nature (e.g xenobiotics). Bioremediation, the deliberate use of microorganisms for the biodegradation of man-made wastes, is an emerging technology that offers cost and practicality advantages over traditional methods of disposal. The success of bioremediation depends on the availability of organisms that are able to detoxify or mineralize pollutants. Microorganisms capable of degrading specific pollutants can be generated by genetic engineering and recursive sequence recombination.

Although bioremediation is an aspect of pollution control, a more useful approach in the long term is one of prevention before industrial waste is pumped into the environment. Exposure of industrial waste streams to microorganisms capable of degrading the pollutants they contain would result in detoxification of mineralization of these pollutants before the waste stream enters the environment. Issues of releasing recombinant organisms can be avoided by containing them within bioreactors fitted to the industrial effluent pipes. This approach would also allow the microbial mixture used to be adjusted to best degrade the particular wastes being produced. Finally, this method would avoid the problems of adapting to the outside world and dealing with competition that face many laboratory microorganisms.

In the wild, microorganisms have evolved new catabolic activities enabling them to exploit pollutants as nutrient sources for which there is no competition. However, pollutants that are present at low concentrations in the environment may not provide a sufficient advantage to stimulate the evolution of catabolic enzymes. For a review of such naturally occurring evolution of biodegradative pathways and the manipulation of some of microorganisms by classical techniques, see Ramos et al., BioTechnology 12:1349-1355 (1994).

Generation of new catabolic enzymes or pathways for bioremediation has thus relied upon deliberate transfer of specific genes between organisms (Wackett et al. Nature 368:627-629 (1994)), forced matings between bacteria with specific catabolic capabilities (Brenner et al. Biodegradation 5:359-377 (1994)), or prolonged selection in a chemostat. Some researchers have attempted to facilitate evolution via naturally occurring genetic mechanisms in their chemostat selections by including microorganisms with a variety of catabolic pathways (Kellogg et. al. Science 214:1133-1135 (1981); Chakrabarty American Society of Micro. Biol. News 62:130-137 (1996)). For a review of efforts in this area, see Cameron et al. Applied Biochem. Biotech. 38:105-140 (1993).

Current efforts in improving organisms for bioremediation take a labor-intensive approach in which many parameters are optimized independently, including transcription efficiency from native and heterologous promoters, regulatory circuits and translational efficiency as well as improvement of protein stability and activity (Timmis et al. Ann. Rev. Microbiol. 48:525-527 (1994)).

The methods described herein permit rapid development of microorganisms having bioremediation capabilities different from and/or superior to naturally occurring microorganisms. Enzyme combinations, activity and specificity can be altered, simultaneously or sequentially, by the methods described herein. For example, catabolic enzymes having an increased rate at which they act on a substrate can be quickly assayed. Although knowledge of a rate-limiting step in a metabolic pathway is not required, rate-limiting proteins in pathways can be developed to have increased expression and/or activity, the requirement for inducing substances can be eliminated, and enzymes can be developed that catalyze novel reactions.

Novel degradation pathways may be developed using the methods described herein. For example, the methods of the invention permit rapid testing of different enzyme combinations that may produce a new bioremediation pathway. Additionally, the methods permit rapid optimization of the specificity and/or efficiency of an enzyme in a bioremediation pathway. When an enzyme is optimized to have a new catalytic function, that function may be expressed either constitutively or in response to a new substrate. Optimization of an enzyme function may involve modification of both structural and regulatory elements (including the structure of regulatory proteins) of a protein. Selection of protein variants that are able to efficiently utilize a new substrate as a nutrient source will be sufficient to ensure that both the enzyme and its regulation are optimized, without a detailed analysis of either protein structure or operon regulation.

Some examples of chemical targets for bioremediation include but are not limited to benzene, xylene, and toluene, camphor, naphthalene, halogenated hydrocarbons, polychlorinated biphenyls (PCBs), trichlorethylene, pesticides such as pentachlorophenyls (PCPs), and herbicides such as atrazine.

A. Aromatic Hydrocarbons

Examples of aromatic hydrocarbons include but are not limited to benzene, xylene, toluene, biphenyl, and polycyclic aromatic hydrocarbons such as pyrene and naphthalene. These compounds are metabolized via catechol intermediates. Degradation of catechol by Pseudomonas putida requires induction of the catabolic operon by cis, cis-muconate which acts on the CatR regulatory protein. The binding site for the CatR protein is G-N₁₁-A, while the optimal sequence for the LysR class of activators (of which CatR is a member) is T-N₁₁-A. Mutation of the G to a T in the CatR binding site enhances the expression of catechol metabolizing genes (Chakrabarty, American Society of Microbiology News 62:130-137 (1996)). This demonstrates that the control of existing catabolic pathways is not optimized for the metabolism of specific xenobiotics. It is also an example of a type of mutant that would be expected from recursive sequence recombination of the operon followed by selection of bacteria that are better able to degrade the target compound.

As an example of starting materials, dioxygenases are required for many pathways in which aromatic compounds are catabolized. Even small differences in dioxygenase sequence can lead to significant differences in substrate specificity (Furukawa et al. J. Bact. 175:5224-5232 (1993); Erickson et al. App. Environ. Micro. 59:3858-3862 (1993)). A hybrid enzyme made using sequences derived from two “parental” enzymes may possess catalytic activities that are intermediate between the parents (Erickson, ibid.), or may actually be better than either parent for a specific reaction (Furukawa et al. J. Bact. 176:2121-2123 (1994)). In one of these cases site directed mutagenesis was used to generate a single polypeptide with hybrid sequence (Erickson, ibid.); in the other, a four subunit enzyme was produced by expressing two subunits from each of two different dioxygenases (Furukawa, ibid.). Thus, sequences from one or more genes encoding dioxygenases can be used in the development of bioremediation pathways according to the methods described herein, to generate enzymes with new specificities. In addition, other features of the catabolic pathway can be developed using these techniques, simultaneously or sequentially, to optimize the metabolic pathway for an activity of interest.

B. Halogenated Hydrocarbons

Large quantities of halogenated hydrocarbons are produced annually for uses as solvents and biocides. These include, in the United States alone, over 5 million tons of both 1,2-dichloroethane and vinyl chloride used in PVC production in the U.S. alone. The compounds are largely not biodegradable by processes in single organisms, although in principle haloaromatic catabolic pathways can be constructed by combining genes from different microorganisms. The methods described herein permit rapid testing of different enzyme combinations as well as testing of protein variants for optimized substrate specificity and/or efficiency to develop novel catabolic pathways.

As an example of possible starting materials for the methods described herein, Wackett et al. (Nature 368:627-629 (1994)) demonstrated that through classical techniques a recombinant Pseudomonas strain in which seven genes encoding two multi-component oxygenases are combined, generated a single host that can metabolize polyhalogenated compounds by sequential reductive and oxidative techniques to yield non-toxic products. These and/or related materials can be subjected to the techniques described herein to develop and optimize a biodegradative pathway.

Trichloroethylene is a significant groundwater contaminant. It is degraded by microorganisms in a cometabolic way (i.e., no energy or nutrients are derived). The enzyme must be induced by a different compound (e.g., Pseudomonas cepacia uses toluene-4-monoxygenase, which requires induction by toluene, to destroy trichloroethylene). Furthermore, the degradation pathway involves formation of highly reactive epoxides that can inactivate the enzyme (Timmis et al. Ann. Rev. Microbiol. 48:525-557 (1994)). The methods described herein can be used to develop enzymatic variants that are less susceptible to epoxide inactivation. In certain embodiments, identification of enzymes that are less susceptible to the epoxides can be accomplished by assaying the cells with extracellular enzyme expression in the presence of increasing concentrations of trichloroethylene.

C. Polychlorinated Biphenyls (PCBs) and Polycyclic Aromatic Hydrocarbons (PAHs)

PCBs and PAHs are families of structurally related compounds that are major pollutants at many Superfund sites. Bacteria transformed with plasmids encoding enzymes with broader substrate specificity have been used commercially. In nature, no known pathways have been generated in a single host that degrade the larger PAHs or more heavily chlorinated PCBs. Indeed, often the collaboration of anaerobic and aerobic bacteria is required for complete metabolism.

Thus, sources of starting material for bioremediation pathway development include genes encoding PAH-degrading catabolic enzymes (Sanseverino et al. Applied Environ. Micro. 59:1931-1937 (1993); Simon et al. Gene 127:31-37 (1993); Zylstra et al. Annals of the NY Acad. Sci. 721:386-398 (1994)), biphenyl and PCB-metabolizing enzymes (Hayase et al. J. Bacteriol. 172:1160-1164 (1990); Furukawa et al. Gene 98:21-28 (1992); Hofer et al. Gene 144:9-16 (1994)). These enzymes and variants thereof may be utilized in the methods disclosed herein to develop novel biodegradative pathways.

Substrate specificity in the PCB pathway largely results from enzymes involved in initial dioxygenation reactions, and can be significantly altered by mutations in those enzymes (Erickson et al. Applied Environ. Micro. 59:3858-38662 (1993); Furukawa et al. J. Bact. 175:5224-5232 (1993). Mineralization of PAHs and PCBs requires that the downstream pathway is able to metabolize the products of the initial reaction (Brenner et al. Biodegradation 5:359-377 (1994)). The methods provided herein will permit development of enzyme pathways and/or enzyme variants that are able to degrade PCB or PAH.

D. Herbicides

Development of novel catabolic pathways for degrading herbicides may be exemplified with respect to atrazine. Atrazine [2-chloro-4-(ethylamino)-6-(isopropylamino)-1,3,5-triazine] is a moderately persistent herbicide which is frequently detected in ground and surface water at concentrations exceeding the 3 ppb health advisory level set by the EPA. Atrazine can be slowly metabolized by a Pseudomonas species (Mandelbaum et al. Appl. Environ. Micro. 61:1451-1457 (1995)). The enzymes catalyzing the first two steps in atrazine metabolism by Pseudomonas are encoded by genes AtzA and AtzB (de Souza et al. Appl. Environ. Micro. 61:3373-3378 (1995)). These genes have been cloned in a 6.8 kb fragment into pUC18 (AtzAB-pUC). E. coli carrying this plasmid converts atrazine to much more soluble metabolites.

E. Heavy Metal Detoxification

Bacteria are used commercially to detoxify arsenate waste generated by the mining of arsenopyrite gold ores. As well as mining effluent, industrial waste water is often contaminated with heavy metals (e.g., those used in the manufacture of electronic components and plastics). Thus, simply to be able to perform other bioremedial functions, microorganisms must be resistant to the levels of heavy metals present, including mercury, arsenate, chromate, cadmium, silver, etc.

A strong selective pressure is the ability to metabolize a toxic compound to one less toxic. Heavy metals are toxic largely by virtue of their ability to denature proteins (Ford et al. Bioextraction and Biodeterioration of Metals, p. 1-23). Detoxification of heavy metal contamination can be effected in a number of ways including changing the solubility or bioavailability of the metal, changing its redox state (e.g. toxic mercuric chloride is detoxified by reduction to the much more volatile elemental mercury) and even by bioaccumulation of the metal by immobilized bacteria or plants. The accumulation of metals to a sufficiently high concentration allows metal to be recycled; smelting bums off the organic part of the organism, leaving behind reusable accumulated metal. Resistances to a number of heavy metals (arsenate, cadmium, cobalt, chromium, copper, mercury, nickel, lead, silver, and zinc) are plasmid encoded in a number of species including Staphylococcus and Pseudomonas (Silver et al. Environ. Health Perspect. 102:107-113 (1994); Ji et al. J. Ind. Micro. 14:61-75 (1995)). These genes also confer heavy metal resistance on other species as well (e.g., E. coli). The methods described herein can be used to develop pathways and/or enzyme variants that increase microbial heavy metal tolerances, as well as to increase the extent to which cells will accumulate heavy metals.

F. Microbial Mining

“Bioleaching” is the process by which microbes convert insoluble metal deposits (usually metal sulfides or oxides) into soluble metal sulfates. Bioleaching is commercially important in the mining of arsenopyrite, but has additional potential in the detoxification and recovery of metals and acids from waste dumps. Naturally occurring bacteria capable of bioleaching are reviewed by Rawlings and Silver (Bio/Technology 13:773-778 (1995)). These bacteria are typically divided into groups by their preferred temperatures for growth. The more important mesophiles are Thiobacillus and Leptospirillum species. Moderate thermophiles include Sulfobacillus species. Extreme thermophiles include Sulfolobus species. Many of these organisms are difficult to grow in commercial industrial settings, making their catabolic abilities attractive candidates for transfer to and optimization in other organisms such as Pseudomonas, Rhodococcus, T. ferrooxidans or E. coli. Genetic systems are available for at least one strain of T. ferrooxidans, allowing the manipulation of its genetic material on plasmids.

The methods described herein can be used to develop new catabolic pathways and/or to optimize the catalytic abilities of one or more enzymes in a pathway, such as the ability to convert metals from insoluble to soluble salts. In addition, leach rates of particular ores can be improved as a result of, for example, increased resistance to toxic compounds in the ore concentrate, increased specificity for certain substrates, ability to use different substrates as nutrient sources, and so on.

G. Oil Desulfurization

The presence of sulfur in fossil fuels has been correlated with corrosion of pipelines, pumping, and refining equipment, and with the premature breakdown of combustion engines. Sulfur also poisons many catalysts used in the refining of fossil fuels. The atmospheric emission of sulfur combustion products is known as acid rain.

Microbial desulfurization is an appealing bioremediation application. Several bacteria have been reported that are capable of catabolizing dibenzothiophene (DBT), which is the representative compound of the class of sulfur compounds found in fossil fuels. U.S. Pat. No. 5,356,801 discloses the cloning of a DNA molecule from Rhodococcus rhodochrous capable of biocatalyzing the desulfurization of oil. Denome et al. (Gene 175:6890-6901 (1995)) disclose the cloning of a 9.8 kb DNA fragment from Pseudomonas encoding the upper naphthalene catabolizing pathway which also degrades dibenzothiophene. Other genes have been identified that perform similar functions (disclosed in U.S. Pat. No. 5,356,801).

The activity of these enzymes is currently too low to be commercially viable, but the pathway could be increased in efficiency using the methods described herein. The desired property of the genes of interest is their ability to desulfurize dibenzothiophene. In certain embodiments, selection is preferably accomplished by coupling this pathway to a pathway providing a nutrient to the bacteria. Thus, for example, desulfurization of dibenzothiophene results in formation of hydroxybiphenyl. This is a substrate for the biphenyl-catabolizing pathway which provides carbon and energy. Pathway development may therefore involve combining components of the dibenzothiophene pathway with components of the biphenyl-catabolizing pathway. Increased dibenzothiophene desulfurization will result in increased nutrient availability and increased growth rate of a host cell. After optimization of individual pathway components, the desulfurization enzymes may be easily separated from the biphenyl degrading enzymes. The latter are undesirable in the final pathway since the object is to desulfurize without decreasing the energy content of the oil.

H. Organo-Nitro Compounds

Organo-nitro compounds are used as explosives, dyes, drugs, polymers and antimicrobial agents. Biodegradation of these compounds occurs usually by way of reduction of the nitrate group, catalyzed by nitroreductases, a family of broadly-specific enzymes. Partial reduction of organo-nitro compounds often results in the formation of a compound more toxic than the original (Hassan et al. 1979 Arch Bioch Biop. 196:385-395). Optimization of nitroreductases can produce enzymes that are more specific, and able to more completely reduce (and thus detoxify) their target compounds (examples of which include but are not limited to nitrotoluenes and nitrobenzenes). Nitro-reductases can be isolated from bacteria isolated from explosive-contaminated soils, such as Morganella morganii and Enterobacter cloacae (Bryant et. al., 1991. J. Biol Chem. 266:4126-4130). A preferred selection method for an enzyme or pathway is to look for increased resistance to the organo-nitro compound of interest, since that will indicate that the enzyme is also able to reduce any toxic partial reduction products of the original compound.

5. Engineering Metabolic Pathways for Chemical Synthesis Using Alternative Substrates

Metabolic engineering can be used to develop pathways that produce industrially useful chemicals and/or pathways that permit host cell growth using alternate and more abundant sources of nutrients, including human-produced industrial wastes.

The starting materials for pathway development according to the methods described herein will typically be genes for utilization of a substrate or its transport. Examples of nutrient sources of interest include but are not limited to lactose, whey, galactose, mannitol, xylan, cellobiose, cellulose and sucrose, thus allowing cheaper production of compounds including but not limited to ethanol, tryptophan, rhamnolipid surfactants, xanthan gum, and polyhydroxylalkanoate. For a review of such substrates as desired target substances, see Cameron et al. (Appl. Biochem. Biotechnol. 38105-140 (1993)).

The pathway development methods described herein can be used to optimize the ability of native hosts or heterologous hosts to utilize a substrate of interest, to evolve more efficient transport systems, to increase or alter specificity for certain substrates, and so on.

6. Engineering Metabolic Pathways for Biosynthesis

Metabolic engineering can be used to alter organisms to optimize the production of practically any metabolic intermediate, including antibiotics, vitamins, amino acids such as phenylalanine and aromatic amino acids, ethanol, butanol, polymers such as xanthan gum and bacterial cellulose, peptides, and lipids. When such compounds are already produced by a host, the pathway development methods described herein can be used to optimize production of the desired metabolic intermediate, including such features as increasing enzyme substrate specificity and turnover number, altering metabolic fluxes to reduce the concentrations of toxic substrates or intermediates, increasing resistance of the host to such toxic compounds, eliminating, reducing or altering the need for inducers of gene expression/activity, increasing the production of enzymes necessary for metabolism, etc.

Metabolic enzymes can also be developed for improved activity in solvents other than water. This is useful because intermediates in chemical syntheses are often protected by blocking groups which dramatically affect the solubility of the compound in aqueous solvents. Many compounds can be produced by a combination of pure chemical and enzymatically catalyzed reactions. Performing enzymatic reactions on almost insoluble substrates is clearly very inefficient, so the availability of enzymes that are active in other solvents will be of great use. One example of such a scheme is the evolution of a para-nitrobenzyl esterase to remove protecting groups from an intermediate in loracarbef synthesis (Moore, J. C. and Arnold, F. H. Nature Biotechnology 14:458-467 (1996)).

In addition, the yield of almost any metabolic pathway can be increased, whether consisting entirely of genes endogenous to the host organisms or all or partly heterologous genes. Optimization of the expression levels of the enzymes in a pathway is more complex than simply maximizing expression. In some cases regulation, rather than constitutive expression of an enzyme may be advantageous for cell growth and therefore for product yield, as seen for production of phenylalanine (Backman et al. Ann. NY Acad. Sci. 589:16-24 (1990)) and 2-keto-L-gluconic acid (Anderson et al. U.S. Pat. No. 5,032,514).

A. Antibiotics

The range of natural small molecule antibiotics includes but is not limited to peptides, peptidolactones, thiopeptides, beta-lactams, glycopeptides, lantibiotics, microcins, polyketide-derived antibiotics (anthracyclins, tetracyclins, macrolides, avermectins, polyethers and ansamycins), chloramphenicol, aminoglycosides, aminocyclitols, polyoxins, agrocins and isoprenoids.

There are at least three ways in which the pathway development methods described herein can be used to facilitate novel drug synthesis, or to improve biosynthesis of existing antibiotics.

First, antibiotic synthesis enzymes can be developed together with transport systems that allow entry of compounds used as antibiotic precursors to improve uptake and incorporation of function-altering artificial side chain precursors. For example, penicillin V is produced by feeding Penicillium the artificial side chain precursor phenoxyacetic acid, and LY146032 by feeding Streptomyces roseosporus decanoic acid (Hopwood, Phil. Trans. R. Soc. Lond. B 324:549-562 (1989)). Poor precursor uptake and poor incorporation by the synthesizing enzyme often lead to inefficient formation of the desired product. Pathway development of these two systems can increase the yield of desired product.

Furthermore, a combinatorial approach can be taken in which enzyme variants can be tested in combination with a variety of other enzymes and tested for biological activity. In this embodiment, the methods involve reactions containing different cells expressing extracellular proteins and a potential antibiotic precursors (such as the side chain analogues) provided in the medium. Combinations of cells that are able to incorporate the new side chain to produce an effective antibiotic may be selected.

Second, novel combinations of antibiotic synthesizing genes from various organisms may be combined and/or optimized during pathway development. Novel enzyme combinations may transform metabolites into new compounds with novel properties. Using traditional methods, introduction of foreign genes into antibiotic synthesizing hosts has already resulted in the production of novel hybrid antibiotics. Examples include mederrhodin, dihydrogranatirhodin, 6-deoxyerythromycin A, isovalerylspiramycin and other hybrid macrolides (Cameron et. al. Appl. Biochem. Biotechnol. 38:105-140 (1993)). The pathway development methods described herein can be used to optimize protein levels of various enzyme combinations, to stabilize the enzyme, and to increase the activity of an enzyme against a new substrate.

Third, the substrate specificity of an enzyme involved in secondary metabolism can be altered so that it will act on and modify a new compound or so that its activity is changed and it acts at a different subset of positions of its normal substrate. The pathway development methods described herein can be used to alter the substrate specificities of enzymes, for example by making and testing a variety of enzyme variants. Furthermore, in addition to testing variants of individual enzymes as a strategy to generate novel antibiotics, testing novel combinations of entire pathways, for example by altering enzyme ratios, will alter metabolite fluxes and may result, not only in increased antibiotic synthesis, but also in the synthesis of different antibiotics. This can be deduced from the observation that expression of different genes from the same cluster in a foreign host leads to different products being formed (see p. 80 in Hutchinson et. al., (1991) Ann NY Acad Sci, 646:78-93). Thus, optimization of an existing antibiotic synthesizing pathway may be used to generate novel antibiotics either by modifying the rates or substrate specificities of enzymes in that pathway.

Additionally, antibiotics can also be produced in vitro by the action of a purified enzyme on a precursor. For example, isopenicillin N synthase catalyses the cyclization of many analogues of its normal substrate (d-(L-a-aminoadipyl)-L-cysteinyl-D-valine) (Hutchinson, Med. Res. Rev. 8:557-567 (1988)). Many of these products are active as antibiotics. A wide variety of substrate analogues can be tested for incorporation by secondary-metabolite synthesizing enzymes without concern for the initial efficiency of the reaction. The pathway development methods described herein can be used subsequently to increase the rate of reaction with a promising new substrate.

Thus, known pathways for producing a desired antibiotic can be evolved the pathway development methods described herein to maximize production of that antibiotic. Additionally, new antibiotics can be developed by manipulation of individual enzymes or development of new enzyme combinations as described herein. Genes for antibiotic production can be transferred to a preferred host after development of a desired pathway. Increases in secondary metabolite production including enhancement of substrate fluxes (by increasing the rate of a rate limiting enzyme, deregulation of the pathway by suppression of negative control elements or over expression of activators and the relief of feedback controls by mutation of the regulated enzyme to a feedback-insensitive deregulated protein) can be achieved using the methods described herein without exhaustive analysis of the regulatory mechanisms governing expression of the relevant gene clusters.

The host chosen for expression of novel pathways and/or enzymes is preferably resistant to the antibiotic produced, although in some instances production methods can be designed so as to sacrifice host cells when the amount of antibiotic produced is commercially significant yet lethal to the host. Similarly, bioreactors can be designed so that the growth medium is continually replenished, thereby “drawing off” antibiotic produced and sparing the lives of the producing cells. Preferably, the mechanism of resistance is not the degradation of the antibiotic produced.

Numerous screening methods for increased antibiotic expression are known in the art, including screening for organisms that are more resistant to the antibiotic that they produce. This may result from linkage between expression of the antibiotic synthesis and antibiotic resistance genes (Chater, BioTechnology 8:115-121 (1990)). Another screening method is to fuse a reporter gene (e.g. xylE from the Pseudomonas TOL plasmid) to the antibiotic production genes. Antibiotic synthesis gene expression can then be measured by looking for expression of the reporter (e.g. xylE encodes a catechol dioxygenase which produces yellow muconic semialdehyde when colonies are sprayed with catechol (Zukowski et al. Proc. Natl. Acad. Sci. U.S.A. 80:1101-1105 (1983)).

The wide variety of cloned antibiotic genes provides a wealth of starting materials for the pathway development methods described herein. For example, genes have been cloned from Streptomyces cattleya which direct cephamycin C synthesis in the non-antibiotic producer Streptomyces lividans (Chen et al. Bio/Technology 6:1222-1224 (1988)). Clustered genes for penicillin biosynthesis (δ-(L-α-arminoadipyl)-L-cysteinyl-D-valine synthetase; isopenicillin N synthetase and acyl coenzyme A:6-aminopenicillanic acid acyltransferase) have been cloned from Penicillium chrysogenum. Transfer of these genes into Neurospora crassa and Aspergillus niger result in the synthesis of active penicillin V (Smith et al. Bio/Technology 8:3941 (1990)). For a review of cloned genes involved in Cephalosporin C, Penicillins G and V and Cephamycin C biosynthesis, see Piepersberg, Crit. Rev. Biotechnol. 14:251-285 (1994). For a review of cloned clusters of antibiotic-producing genes, see Chater BioTechnology 8:115-121 (1990). Other examples of antibiotic synthesis genes transferred to industrial producing strains, or over expression of genes, include tylosin, cephamycin C, cephalosporin C, LL-E33288 complex (an antitumor and antibacterial agent), doxorubicin, spiramycin and other macrolide antibiotics, reviewed in Cameron et al. Appl. Biochem. Biotechnol. 38:105-140 (1993).

B. Biosynthesis to Replace Chemical Synthesis of Antibiotics

Some antibiotics are currently made by chemical modifications of biologically produced starting compounds. Complete biosynthesis of the desired molecules may currently be impractical because of the lack of an enzyme with the required enzymatic activity and substrate specificity. For example, 7-aminodeacetooxycephalosporanic acid (7-ADCA) is a precursor for semi-synthetically produced cephalosporins. 7-ADCA is made by a chemical ring expansion from penicillin V followed by enzymatic deacylation of the phenoxyacetal group. Cephalosporin V could in principle be produced biologically from penicillin V using penicillin N expandase, but penicillin V is not used as a substrate by any known expandase. The pathway development methods described herein can be used to identify enzyme variants that will use penicillin V as a substrate. Similarly, variants of penicillin transacylase that accept cephalosporins or cephamycins as substrates may be developed.

In yet another example, penicillin amidase expressed in E. coli is a key enzyme in the production of penicillin G derivatives. The enzyme is generated from a precursor peptide and tends to accumulate as insoluble aggregates in the periplasm unless non-metabolizable sugars are present in the medium (Scherrer et al. Appl. Microbiol. Biotechnol. 42:85-91 (1994)). Development of variants of this enzyme using the methods described herein permit generation of an enzyme that folds better, leading to a higher level of active enzyme expression.

In yet another example, Penicillin G acylase covalently linked to agarose is used in the synthesis of penicillin G derivatives. The enzyme can be stabilized for increased activity, longevity and/or thermal stability by chemical modification (Fernandez-Lafuente et. al. Enzyme Microb. Technol. 14:489-495 (1992)). The methods described herein may be used to develop enzymes having increased thermal stability thereby obviating the need for the chemical modification of such enzymes. Selection for thermostability can be performed by carrying out the reactions described herein at higher temperatures. In general, thermostability is a good first step in enhancing general stabilization of enzymes. Mutagenesis and selection can also be used to adapt enzymes to function in non-aqueous solvents (Arnold Curr Opin Biotechnol, 4:450-455 (1993); Chen et. al. Proc. Natl. Acad. Sci. U.S.A., 90:5618-5622 (1993)).

C. Polyketides

Polyketides include antibiotics such as tetracycline and erythromycin, anti-cancer agents such as daunomycin, immunosuppressants such as FK506 and rapamycin and veterinary products such as monesin and avermectin. Polyketide synthases (PKS's) are multifunctional enzymes that control the chain length, choice of chain-building units and reductive cycle that generates the huge variation in naturally occurring polyketides. Polyketides are built up by sequential transfers of “extender units” (fatty acyl CoA groups) onto the appropriate starter unit (examples are acetate, coumarate, propionate and malonamide). The PKS's determine the number of condensation reactions and the type of extender groups added and may also fold and cyclize the polyketide precursor. PKS's reduce specific β-keto groups and may dehydrate the resultant β-hydroxyls to form double bonds. Modifications of the nature or number of building blocks used, positions at which β-keto groups are reduced, the extent of reduction and different positions of possible cyclizations, result in formation of different final products. Polyketide research is currently focused on modification and inhibitor studies, site directed mutagenesis and 3-D structure elucidation to lay the groundwork for rational changes in enzymes that will lead to new polyketide products.

McDaniel et al. (Science 262:1546-1550 (1995)) have developed a Streptomyces host-vector system for efficient construction and expression of recombinant PKSs. Hutchinson (BioTechnology 12:375-308 (1994)) reviewed targeted mutation of specific biosynthetic genes and suggested that microbial isolates can be screened by DNA hybridization for genes associated with known pharmacologically active agents so as to provide new metabolites and large amounts of old ones. In particular, that review focuses on polyketide synthase and pathways to aminoglycoside and oligopeptide antibiotics.

The pathway development methods described herein can be used to generate novel pathways and/or modified enzymes that produce novel polyketides. The availability of the PKS genes on plasmids and the existence of E. coli-Streptomyces shuttle vectors (Wehmeier Gene 165:149-150 (1995)) facilitates that pathway development methods described herein. Techniques for selection of antibiotic producing organisms can be performed as described further herein. Additionally, in some embodiments, screening for a particular desired polyketide activity or compound may be used.

D. Isoprenoids

Isoprenoids result from cyclization of farnesyl pyrophosphate by sesquiterpene synthases. The diversity of isoprenoids is generated not by the backbone, but by control of cyclization. Cloned examples of isoprenoid synthesis genes include trichodiene synthase from Fusarium sprorotrichioides, pentalene synthase from Streptomyces, aristolochene synthase from Penicillium roquefortii, and epi-aristolochene synthase from N. tabacum (Cane, D. E. (1995). Isoprenoid antibiotics, pages 633-655, in “Genetics and Biochemistry of Antibiotic Production” edited by Vining, L. C. & Stuttard, C., published by Butterworth-Heinemann). The pathway development methods described herein may be used to produce variants of sesquiterpene synthases useful both in allowing expression of these enzymes in heterologous hosts (such as plants and industrial microbial strains) and in alteration of enzymes to change the cyclized product made. A large number of isoprenoids are active as antiviral, antibacterial, antifungal, herbicidal, insecticidal or cytostatic agents. Antibacterial and antifungal isoprenoids could thus be screened for using an indicator cell type system or by their ability to confer resistance to viral attack on a host cell.

E. Bioactive Peptide Derivatives

Examples of bioactive non-ribosomally synthesized peptides include the antibiotics cyclosporin, pepstatin, actinomycin, gramicidin, depsipeptides, vancomycin, etc. These peptide derivatives are synthesized by complex enzymes rather than ribosomes. Again, increasing the yield of such non-ribosomally synthesized peptide antibiotics has thus far been done by genetic identification of biosynthetic “bottlenecks” and over expression of specific enzymes (See, for example, p. 133-135 in “Genetics and Biochemistry of Antibiotic Production” edited by Vining, L. C. & Stuttard, C., published by Butterworth-Heinemann (1995)). The pathway development methods described herein can be used to improve the yields of existing bioactive non-ribosomally made peptides by identifying novel enzyme combinations and/or by developing enzymes with optimized activity or specificity. Like polyketide synthases, peptide synthases are modular and multifunctional enzymes catalyzing condensation reactions between activated building blocks (in this case amino acids) followed by modifications of those building blocks (see Kleinkauf, H. and von Dohren, H. Eur. J. Biochem. 236:335-351 (1996)). Thus, as for polyketide synthases, the methods described herein can be used to identify peptide synthase variants having a modified specificity for the amino acid recognized by each binding site on the enzyme and an altered activity or substrate specificity for sites that modify these amino acids to produce novel compounds with antibiotic activity.

Other peptide antibiotics are made ribosomally and then post-translationally modified. Examples of this type of antibiotics are lantibiotics (produced by gram positive bacteria such Staphylococcus, Streptomyces, Bacillus, and Actinoplanes) and microcins (produced by Enterobacteriaceae). Modifications of the original peptide include (in lantibiotics) dehydration of serine and threonine, condensation of dehydroamino acids with cysteine, or simple N— and C-terminal blocking (microcins). For ribosomally made antibiotics both the peptide-encoding sequence and the modifying enzymes may be tested at varying concentration ratios using the methods described herein. Again, this will lead to both increased levels of antibiotic synthesis, and by modulation of the levels of the modifying enzymes (and the sequence of the ribosomally synthesized peptide itself) novel antibiotics.

F. Polymers

Several examples of metabolic engineering to produce biopolymers have been reported, including the production of the biodegradable plastic polyhydroxybutarate, (PHB), and the polysaccharide xanthan gum. For a review, see Cameron et al. Applied Biochem. Biotech. 38:105-140 (1993). Genes for these pathways have been cloned, making them excellent candidates for the pathway development methods described herein.

Examples of starting materials for pathway development include but are not limited to genes from bacteria such as Alcaligenes, Zoogloea, Rhizobium, Bacillus, and Azobacter, which produce polyhydroxyalkanoates (PHAs) such as polyhyroxybutyrate (PHB) intracellularly as energy reserve materials in response to stress. Genes from Alcaligenes eutrophus that encode enzymes catalyzing the conversion of acetoacetyl CoA to PHB have been transferred both to E. coli and to the plant Arabidopsis thaliana (Poirier et al. Science 256:520-523 (1992)). Two of these genes (phbB and phbC, encoding acetoacetyl-CoA reductase and PHB synthase respectively) allow production of PHB in Arabidopsis. The plants producing the plastic are stunted, probably because of adverse interactions between the new metabolic pathway and the plants' original metabolism (i.e., depletion of substrate from the mevalonate pathway). Improved production of PHB in plants has been attempted by localization of the pathway enzymes to organelles such as plastids. Other strategies such as regulation of tissue specificity, expression timing and cellular localization have been suggested to solve the deleterious effects of PHB expression in plants. The pathway development methods described herein can be used to modify such heterologous genes as well as specific cloned interacting pathways (e.g., mevalonate), and to optimize PHB synthesis in industrial microbial strains, for example to remove the requirement for stresses (such as nitrogen limitation) in growth conditions.

Additionally, other microbial polyesters are made by different bacteria in which additional monomers are incorporated into the polymer (Peoples et al. in Novel Biodegradable Microbial Polymers, E A Dawes, ed., pp 191-202 (1990)). The pathway development methods described herein will allow the production of a variety of polymers with differing properties, including variation of the monomer subunit ratios in the polymer. Another polymer whose synthesis may be manipulated by the methods described herein is cellulose. The genes for cellulose biosynthesis have been cloned from Agrobacterium tumefaciens (Matthysse, A. G. et. al. J. Bacteriol. 177:1069-1075 (1995)). Pathway development of this biosynthetic pathway could be used either to increase synthesis of cellulose, or to produce mutants in which alternative sugars are incorporated into the polymer.

G. Carotenoids

Carotenoids are a family of over 600 terpenoids produced in the general isoprenoid biosynthetic pathway by bacteria, fungi and plants (for a review, see Armstrong, J. Bact. 176:4795-4802 (1994)). These pigments protect organisms against photooxidative damage as well as functioning as anti-tumor agents, free radical-scavenging anti-oxidants, and enhancers of the immune response. Additionally, they are used commercially in pigmentation of cultured fish and shellfish. Examples of carotenoids include but are not limited to myxobacton, spheroidene, spheroidenone, lutein, astaxanthin, violaxanthin, 4-ketorulene, myxoxanthrophyll, echinenone, lycopene, zeaxanthin and its mono- and di-glucosides, alpha-, beta-, gamma- and delta-carotene, beta-cryptoxanthin monoglucoside and neoxanthin.

Carotenoid synthesis is catalyzed by relatively small numbers of clustered genes: 11 different genes within 12 kb of DNA from Myxococcus xanthus (Botella et al. Eur. J. Biochem. 233:238-248 (1995)) and 8 genes within 9 kb of DNA from Rhodobacter sphaeroides (Lang et. al. J. Bact. 177:2064-2073 (1995)). In some microorganisms, such as Thermus thermophilus, these genes are plasmid-borne (Tabata et al. FEBS Letts 341:251-255 (1994)).

Transfer of some carotenoid genes into heterologous organisms results in expression. For example, genes from Erwina uredovora and Haematococcus pluvialis will function together in E. coli (Kajiwara et al. Plant Mol. Biol. 29:343-352 (1995)). E. herbicola genes will function in R. sphaeroides (Hunter et al. J. Bact. 176:3692-3697 (1994)). However, some other genes do not; for example, R. capsulatus genes do not direct carotenoid synthesis in E. coli (Marrs, J. Bact. 146:1003-1012 (1981)).

The methods described herein can be used to develop variants of one or more carotenoid synthesis genes that have optimized catalytic activity. Since carotenoids are colored, a calorimetric assay in microtiter plates, or even on growth media plates, can be used for screening variants.

In addition to increasing activity of carotenoids, carotenogenic biosynthetic pathways have the potential to produce a wide diversity of carotenoids, as the enzymes involved appear to be specific for the type of reaction they will catalyze, but not for the substrate that they modify. For example, two enzymes from the marine bacterium Agrobacterium aurantiacum (CrtW and CrLZ) synthesize six different ketocarotenoids from beta-carotene (Misawa et al. J. Bact. 177:6576-6584 (1995)). This relaxed substrate specificity means that a diversity of substrates can be transformed into an even greater diversity of products. Novel combinations of carotenoid genes can lead to novel and functional carotenoid-protein complexes, for example in photosynthetic complexes (Hunter et al. J. Bact. 176:3692-3697 (1994)).

Another method of identifying new compounds is to use standard analytical techniques such as mass spectroscopy, nuclear magnetic resonance, high performance liquid chromatography, etc. Recombinant microorganisms can be pooled and extracts or media supernatants assayed from these pools. Any positive pool can then be subdivided and the procedure repeated until the single positive is identified (“sib-selection”).

H. Indigo Biosynthesis

Many dyes, i.e. agents for imparting color, are specialty chemicals with significant markets. As an example, indigo is currently produced chemically. However, nine genes have been combined in E. coli to allow the synthesis of indigo from glucose via the tryptophan/indole pathway (Murdock et al. Biotechnology 11:381-386 (1993)). A number of manipulations were performed to optimize indigo synthesis: cloning of nine genes, modification of the fermentation medium and directed changes in two operons to increase reaction rates and catalytic activities of several enzymes. Nevertheless, bacterially produced indigo is not currently an economic proposition. The pathway development methods described herein could be used to optimize indigo synthesizing pathways and/or enzyme catalytic activities, leading to increased indigo production, thereby making the process commercially viable and reducing the environmental impact of indigo manufacture. Screening for increased indigo production can be done by calorimetric assays of cultures in microtiter plates.

I. Amino Acids

Amino acids of particular commercial importance include but are not limited to phenylalanine, monosodium glutamate, glycine, lysine, threonine, tryptophan and methionine. Backman et al. (Ann. NY Acad. Sci. 589:16-24 (1990)) disclosed the enhanced production of phenylalanine in E. coli via a systematic and downstream strategy covering organism selection, optimization of biosynthetic capacity, and development of fermentation and recovery processes.

As described in Simpson et al. (Biochem Soc Trans, 23:381-387 (1995)), current work in the field of amino acid production is focused on understanding the regulation of these pathways in great molecular detail. The pathway development methods described herein permit optimization of pathways for amino acid synthesis and secretion as well as optimization of enzymes at the regulatory phosphoenolpyruvate branchpoint, from such organisms as Serratia marcescens, Bacillus, and the Corynebacterium-Brevibacterium group. In certain embodiments, screening for enhanced production may be using chemical tests well known in the art that are specific for the desired amino acid. Screening/selection for amino acid synthesis can also be done by using auxotrophic reporter cells that are themselves unable to synthesize the amino acid in question.

J. Vitamin C Synthesis

L-Ascorbic acid (vitamin C) is a commercially important vitamin with a world production of over 35,000 tons in 1984. Most vitamin C is currently manufactured chemically by the Reichstein process, although recently bacteria have been engineered that are able to transform glucose to 2,5-keto-gluconic acid, and that product to 2-keto-L-idonic acid, the precursor to L-ascorbic acid (Boudrant, Enzyme Microb. Technol. 12:322-329 (1990)).

The efficiencies of these enzymatic steps in bacteria are currently low. Using the pathway development techniques described herein, novel pathways and/or enzymes can be designed resulting in optimization of a hybrid L-ascorbic acid synthetic pathways to result in commercially viable vitamin C biosynthesis.

K. Terpenoids

Terpenoids constitute the largest family and chemically most diversified group of natural products. An amazing number of 23,000 different terpenoid compounds have been described and hundreds of new structures continue to be identified every year (Connolly & Hill, Dictionary of Terpenoids, Chapman & Hall, London, 1991). The enormous diversity of terpenoid structures reflects the importance and the diversity of functions of terpenoids in biological systems. Terpenoids serve as hormones (e.g. gibberellins), photosynthetic pigments (phytol, carotenoids), antioxidants (e.g. carotenoids), electron carrier (e.g. ubiquinone), mediators of polysaccharide assembly (polyprenyl diphosphates) and as membrane components (sterols, hopanoids). Monoterpenes are common fragrances and flavors. Many sesquiterpenes and diterpenes function as defensive agents, visual pigments, antitumor drugs and as signal transduction components. In plants, the monoterpenoids (10 carbon backbone) are known as constituents of essential oils and are responsible for the characteristic scent of the plants in which they occur, and a diversity of structural types are used as flavorings and scents. In addition, many of these compounds have biological activity, and many of the therapeutically active components in plants and herbs that have been traditionally used for the treatment of a variety of diseases are terpenoids. Examples include artemisinin, a sesquiterpene isolated from wormwood that is used for the treatment of fevers and malaria; taxol, a diterpene isolated from pacific yew that is one of the most effective anticancer drugs and forskolin, a diterpene isolated from an Indian medicinal plant lowers blood pressure and has cardio active properties. A variety of terpenoids have antibacterial and antifungal properties or are potent cell toxins like for example the trichoethecene sesquiterpenes isolated from certain fungi. Important terpenoid agrochemicals are e.g. the insecticidal pyerethrins (monoterpenes) and azadrachtin (triterpenoid). For a review on medicinal and agrochemical properties of terpenoids, see Dewick (Medicinal Natural Products, John Wiley & Sons, New York, 1998). Both the amazing chemical diversity and functional diversity of terpenoids, makes them possible the most promising class of natural products for the discovery of a variety of compounds of economic value (Sacchettini and Poulter, Science 1997; 277:1788-1790).

Various enzymatic pathways leads to the formation of a variety of terpenoids, e.g., monoterpenoids, sesquiterpendoids (15 carbon backbone), diterpenoids (20 carbon backbone), and tetraterpenoids (40 carbon backbone). Of the monoterpenes, there are three main groups; acyclic terpenes such as geraniol, moncyclic species such terpineol, and bicyclic species such as camphor and thujone.

The biosynthetic pathways for terpenes, carotenoids, and steroids all begin with the condensation of two molecules of acetyl-CoA, catalyzed by the enzyme acetoacetyl-CoA thiolase. The second step is catalyzed by the enzyme hydroxyglutaryl-SCoA (HGM-SCoA) synthase. The product, HMG-CoA is reduced to produce mevalonic acid by HMG-CoA reductase. The mevalonic acid is phosphorylated to produce MVA-5 pyrophosphate, which is carboxylated to produce isopentenyl pyrophosphate (EPP). In the first committed step in isoprenoid biosynthesis, the linear 10-carbon (C10) geranyl diphosphate (GDP) molecule is formed via a head-to-tail condensation (1′-4 addition) of two C5 isoprene units; IPP and its isomer; dimethylallyl diphosphate (DMAPP). GDP, the precursor of all terpenoids; geranyl diphosphate, may thereafter undergo chain elongation and/or cyclization.

6. Screening Techniques

Screening techniques for identification and/or detection of a desired or novel product are generally described above. Additionally, screening may be carried out by detection of expression of a selectable marker, which, in some genetic circumstances, allows cells expressing the marker to survive while other cells die (or vice versa). Screening markers include, for example, luciferase, beta-galactosidase, and green fluorescent protein. Screening can also be done by observing such aspects of growth as colony size, halo formation, etc. Additionally, screening for production of a desired compound, such as a therapeutic drug or “designer chemical” can be accomplished by observing binding of cell products to a receptor or ligand, such as on a solid support or on a column. Such screening can additionally be accomplished by binding to antibodies, as in an ELISA. In some instances the screening process is preferably automated so as to allow screening of suitable numbers of reactions. Some examples of automated screening devices include fluorescence activated cell sorting, especially in conjunction with cells immobilized in agarose (see Powell et. al. Bio/Technology 8:333-337 (1990); Weaver et. al. Methods 2:234-247 (1991)), automated ELISA assays, etc. Selectable markers can include, for example, drug, toxin resistance, or nutrient synthesis genes. Selection is also done by such techniques as growth on a toxic substrate to select for hosts having the ability to detoxify a substrate, growth on a new nutrient source to select for hosts having the ability to utilize that nutrient source, competitive growth in culture based on ability to utilize a nutrient source, etc.

Screens for antibiotic production are generally described in Hopwood (Phil Trans R. Soc. Lond B 324:549-562 (1989)). Omura (Microbio. Rev. 50:259-279 (1986)) and Nisbet (Ann Rep. Med. Chem. 21:149-157 (1986)) disclose screens for antimicrobial agents, including supersensitive bacteria, detection of beta-lactamase and D,D-carboxypeptidase inhibition, beta-lactamase induction, chromogenic substrates and monoclonal antibody screens. Antibiotic targets can also be used as screening targets in high throughput screening. Antifungals are typically screened by inhibition of fungal growth. Pharmacological agents can be identified as enzyme inhibitors using plates containing the enzyme and a chromogenic substrate, or by automated receptor assays. Hydrolytic enzymes (e.g., proteases, amylases) can be screened by including the substrate in an agar plate and scoring for a hydrolytic clear zone or by using a calorimetric indicator (Steele et al. Ann. Rev. Microbiol. 45:89-106 (1991)). This can be coupled with the use of stains to detect the effects of enzyme-action (such as congo red to detect the extent of degradation of celluloses and hemicelluloses). Tagged substrates can also be used. For example, lipases and esterases can be screened using different lengths of fatty acids linked to umbelliferyl. The action of lipases or esterases removes this tag from the fatty acid, resulting in a quenching of umbelliferyl fluorescence. These enzymes can be screened in microtiter plates by a robotic device.

Efficient screening techniques are needed to provide efficient development of novel pathways using the methods described-herein. Preferably, suitable screening techniques for compounds produced by the enzymatic pathways allow for a rapid and sensitive screen for the properties of interest. Visual (calorimetric) assays are optimal in this regard, and are easily applied for compounds with suitable light absorption properties. Moreover, the successes of combinatorial chemistry in drug development and directed enzyme evolution have spurred the development of more and more sophisticated screening technology. This includes, for instance, high-throughput HPLC-MS analysis, where screening robots are connected to HPLC-MS systems for automated injection and rapid sample analysis. These techniques allow for high-throughput detection and quantification of virtually any desired compound. HPLC-MS, TLC, and screening of microtiter plates using a plate reader, can be used to identify novel carotenoids demonstrating only small differences in their absorption properties. Screening and selection techniques for directed enzyme evolution, which techniques may be adaptable for use in the methods described herein, have been reviewed (Zhao, H. and Arnold, F., Curr. Opin. Struct. Biol. 1997; 7: 480-485; Hilvert, D. and Kast, P., Curr. Opin. Struct. Biol. 1997; 7: 470-479).

As terpenoids do not have any light absorbing or fluorescence properties, analysis of terpene biosynthesis relies either on the use of radio-labeled substrates and radio-GC/HPLC or on GC/HPLC-MS. Both radio-GC and GC-MS are the predominant methods described for terpene analysis in literature. However, HPLC-MS has also been used, especially for the less or non-volatile terpenoids with 15 or more carbon atoms (Bohlmann et al., Proc. Natl. Acad. Sci. USA 1998;95:4126-4133; Corey et al., Proc. Natl. Acad. Sci. USA 1994;91:2211-2215; Thomas et al., Proc. Natl. Acad. Sci. USA 1999;96:4698-4703). Hence, HPLC-MS methods for the analysis and quantification of terpenoids can be developed. GC-MS can be used for routine analysis of biosynthesis of known terpenoids. For both HPLC and GC analysis, methods described in literature can be adapted to the actual analytical needs and to existing equipment. Methods for terpenoid extraction and sample preparation for GC/LC-MS analysis is preferably developed based on published material. Special emphasis should be put on the development of methods requiring only few simple steps that are adaptable to high-throughput sample analysis. Furthermore, known terpenes can be isolated as standards for GC/LC-MS analysis according to published methods. The wealth of published terpenoid mass spectra and of those deposited in the NIST database can also be recruited for terpenoid identification. In some cases, structural identification by high-resolution NMR and mass spectrometry may become necessary.

Since carotenoids exhibit specific absorption properties depending on their chromophore, novel carotenoids can be distinguished by their altered light absorption properties when the enzymatic modifications affect the chromophore. In order to facilitate screening based on altered spectrophotometrical properties for synthesis of novel carotenoids, biosynthesis enzymes are chosen for pathway development which affect the chromophore by, e.g., desaturation, oxygenation or cyclization. Detailed methods for carotenoid analysis are found in Britton et al., In: Carotenoids: Volume 1A: Isolation and Analysis, Basel: Birkhuser Verlag (1998); and Britton et al., In: Carotenoids: Volume 1B: Isolation and Analysis, Basel:Birkhuser Verlag (1998).

Since flavonoids exhibit specific absorption properties depending on their chromophore, novel flavonoids can be distinguished by their altered light absorption properties when the enzymatic modifications affect the chromophore. In order to facilitate screening based on altered spectrophotometrical properties for synthesis of novel flavonoids, biosynthesis enzymes are chosen for pathway development which affect the chromophore by, e.g., desaturation, oxygenation or cyclization. Other modifications of the flavonoid structures can be detected by, e.g., LC-MS techniques.

Tetrapyrroles not only exhibit characteristic light absorption spectra, but also distinct fluorescent properties. Most modifications of the tetrapyrrole ring system by oxidation, metal chelation or side-chain modifications will result in a different delocalization state of the ring system and thus influence its fluorescent and light absorption properties. Therefore, light absorption and fluorescence serves as ideal tools for tetrapyrrole analysis (along with HPLC and NMR) and screening.

Prior to modification of any biosynthetic enzyme for the synthesis of novel tetrapyrroles, the absorption and fluorescent properties of every tetrapyrrole (precorrin-2, precorrin-3, coproporphyrinogen III, protoporphyrinogen IX, protoporphyrin and protohaem IX) serving as substrates for enzymes to be modified, can be analyzed and compared to published properties. In addition, extraction methods for isolation and HPLC methods can be established based on literature methods.

The practice of the present methods will employ, unless otherwise indicated, conventional techniques of cell biology, cell culture, molecular biology, transgenic biology, microbiology, recombinant DNA, and immunology, engineering, robotics, optics, computer software and integration. The techniques and procedures are generally performed according to conventional methods in the art and various general references. which are within the skill of the art. Such techniques are explained fully in the literature. See, for example, Molecular Cloning A Laboratory Manual, 2^{nd} Ed., ed. by Sambrook, Fritsch and Maniatis (Cold Spring Harbor Laboratory Press: 1989); DNA Cloning, Volumes I and II (D. N. Glover ed., 1985); Oligonucleotide Synthesis (M. J. Gait ed., 1984); Mullis et al. U.S. Pat. No. 4,683,195; Nucleic Acid Hybridization (B. D. Hames & S. J. Higgins eds. 1984); Transcription And Translation (B. D. Hames & S. J. Higgins eds. 1984); Culture Of Animal Cells (R. L. Freshney, Alan R. Liss, Inc., 1987); Immobilized Cells And Enzymes (IRL Press, 1986); B. Perbal, A Practical Guide To Molecular Cloning (1984); the treatise, Methods In Enzymology (Academic Press, Inc., N.Y.); Gene Transfer Vectors For Mammalian Cells (J. H. Miller and M. P. Calos eds., 1987, Cold Spring Harbor Laboratory); Methods In Enzymology, Vols. 154 and 155 (Wu et al. eds.), Immunochemical Methods In Cell And Molecular Biology (Mayer and Walker, eds., Academic Press, London, 1987); Handbook Of Experimental Immunology, Volumes I-IV (D. M. Weir and C. C. Blackwell, eds., 1986); Manipulating the Mouse Embryo, (Cold Spring Harbor Laboratory Press, Cold Spring Harbor, N.Y., 1986); Lakowicz, J. R. Principles of Fluorescence Spectroscopy, New York:Plenum Press (1983), and Lakowicz, J. R. Emerging Applications of Fluorescence Spectroscopy to Cellular Imaging: Lifetime Imaging, Metal-ligand Probes, Multi-photon Excitation and Light Quenching, Scanning Microsc. Suppl VOL. 10 (1996) pages 213-24, for fluorescent techniques, Optics Guide 5 Melles Griot.RTM. Irvine Calif. for general optical methods, Optical Waveguide Theory, Snyder & Love, published by Chapman & Hall, and Fiber Optics Devices and Systems by Peter Cheo, published by Prentice-Hall for fiber optic theory and materials.

Equivalents

The present invention provides among other things compositions and methods for metabolic engineering. While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

### INCORPORATION BY REFERENCE

All publications and patents mentioned herein, including those items listed below, are hereby incorporated by reference in their entirety as if each individual publication or patent was specifically and individually indicated to be incorporated by reference. In case of conflict, the present application, including any definitions herein, will control.

Also incorporated by reference in their entirety are any polynucleotide and polypeptide sequences which reference an accession number correlating to an entry in a public database, such as those maintained by The Institute for Genomic Research (TIGR) (www.tigr.org) and/or the National Center for Biotechnology Information (NCBI) (www.ncbi.nlm.nih.gov).

What is claimed is:

1. A method for engineering a pathway that produces a desired product, comprising:
i) mixing two or more cells in a reaction mixture comprising a substrate for the pathway, wherein said cells extracellularly express potential pathway components;
ii) assaying the reaction mixture for production of the desired product.

2. The method of claim 1, wherein said cells express the potential pathway components on the cell surface.

3. The method of claim 1, wherein said cells secrete the potential pathway components into the extracellular environment.

4. The method of claim 1, wherein said cells are prokaryotic cells.

5. The method of claim 4, wherein said cells are bacterial cells.

6. The method of claim 5, wherein said cells are E. coli.

7. The method of claim 1, wherein said cells are eukaryotic cells.

8. The method of claim 7, wherein said cells are yeast cells.

9. The method of claim 1, wherein 3 or more cells are mixed in the reaction mixture.

10. The method of claim 1, wherein a plurality of cells are mixed in the reaction mixture.

11. The method of claim 1, wherein expression of the potential pathway components is dependent on the presence of an appropriate substrate in the reaction mixture.

12. The method of claim 1, wherein viability or proliferation of a cell expressing a potential pathway component is regulatable.

13. The method of claim 12, wherein viability or proliferation of a cell expressing a potential pathway component is dependent on the presence of a component in the reaction mixture.

14. The method of claim 1, wherein each cell expresses at least one potential pathway component.

15. The method of claim 1, wherein at least one cell expresses at least two potential pathway components.

16. A method for engineering a pathway for biodegradation of an input substance, comprising:
i) mixing two or more cells in a reaction mixture comprising an input substance for degradation by the pathway, wherein said cells extracellularly express potential pathway components;
ii) assaying the reaction mixture for degradation of the input substance.

17. The method of claim 16, wherein the reaction mixture is assayed for disappearance of the input substance.

18 The method of claim 16, wherein the reaction mixture is assayed for production of a breakdown product.

19. A library comprising a plurality of cells extracellularly expressing a plurality of potential pathway components.

20. The library of claim 19, wherein said cells express said potential pathway components on the cell surface.

21. The library of claim 19, wherein said cells secrete said potential pathway components into the extracellular environment.

22. The library of claim 19, wherein said plurality of potential pathway components comprise enzymes involved in a biodegradation pathway, or variants thereof.

23. The library of claim 19, wherein said plurality of potential pathway components comprise enzymes involved in a biosynthetic pathway, or variants thereof.

24. The library of claim 19, wherein said plurality of potential pathway components comprise two or more variants of at least one metabolic or catabolic enzyme.

25. The library of claim 24, wherein said plurality of potential pathway components comprise a plurality of variants of at least one metabolic or catabolic enzyme.

26. The library of claim 19, wherein each cell expresses at least one potential pathway component.

27. The library of claim 19, wherein at least one cell expresses at least two potential pathway components.

28. The library of claim 27, wherein a plurality of cells each express at least two potential pathway components.
